(19) United States
(12) Patent Application Publication
(10) Pub. No.: US 2019/0168210 A1
(43) Pub. Date: Jun. 6, 2019

(54) Devices and Methods for Sample Collection

(71) Applicant: SISCAPA Assay Technologies, Inc., Washington, DC (US)

(72) Inventor: N. Leigh Anderson, Washington, DC (US)

(73) Assignee: SISCAPA Assay Technologies, Inc., Washington, DC (US)

(21) Appl. No.: 16/206,519

(22) Filed: Nov. 30, 2018

Related U.S. Application Data
(63) Continuation-in-part of application No. PCT/US2017/035054, filed on May 30, 2017.
(60) Provisional application No. 62/651,523, filed on Apr. 2, 2018.
(60) Provisional application No. 62/626,843, filed on Feb. 6, 2018.
(60) Provisional application No. 62/596,657, filed on Dec. 8, 2017.
(60) Provisional application No. 62/618,486, filed on Jan. 17, 2018.
(60) Provisional application No. 62/504,478, filed on May 10, 2017.
(60) Provisional application No. 62/418,538, filed on Nov. 7, 2016.
(60) Provisional application No. 62/362,443, filed on Jul. 14, 2016.
(60) Provisional application No. 62/343,705, filed on May 31, 2016.

(51) Int. Cl. B01L 3/00

(52) U.S. Cl. CPC B01L 3/5023; B01L 3/52; B01L 2400/0406; B01L 2300/123; B01L 2300/0861; B01L 2300/021; B01L 2300/165

(57) ABSTRACT

The present invention relates to devices and methods for collecting, stabilizing and further processing samples, including biological samples such as blood. The invention allows a measurable volume of blood to be introduced into a container, dried by a desiccant in the same or a contacting container, and finally recovered and further processed in a format compatible with a robotic sample processing system. The invention allows collection and processing of larger amounts of blood (20-100 μl or more) than are conveniently recovered and processed using conventional dried blood spots on filter paper, and to do so under the control of a mobile device such as a smartphone.

This application claims the benefit of U.S. Provisional Patent Application No. 62/651,523 filed Apr. 2, 2018, U.S. Provisional Patent Application No. 62/626,843 filed Feb. 6, 2018, U.S. Provisional Patent Application No. 62/618,486 filed Jan. 17, 2018, and U.S. Provisional Patent Application No. 62/596,657 filed Dec. 8, 2017, and is a continuation-in-part of International Patent Application No. PCT/US2017/035054 filed May 30, 2017, which claims the benefit of U.S. Provisional Patent Application No. 62/504,478 filed May 10, 2017, U.S. Provisional Patent Application No. 62/418,538 filed Nov. 7, 2016, U.S. Provisional Patent Application No. 62/362,443 filed Jul. 14, 2016, and U.S. Provisional Patent Application No. 62/343,705 filed May 31, 2016, the content of each of which applications is incorporated herein by reference.

Incorporated by reference herein in their entirety are the contents of each of the below patent documents, each in its entirety:

U.S. Pat. No. 7,632,686 (application Ser. No. 10/676,005), entitled High Sensitivity Quantitation of Peptides by Mass Spectrometry; filed 2 Oct. 2003;

PCT/US2011/028569, entitled Improved Mass Spectrometric Assays For Peptides filed 15 Mar. 2011;

Ser. No. 11/256,946, entitled Process For Treatment Of Protein Samples, filed 25 Oct. 2005;

Ser. No. 12/042,931, entitled Magnetic Bead Trap and Mass Spectrometer Interface;

PCT/US 16/13876, entitled Combined Analysis Of Small Molecules And Proteins By Mass Spectrometry

PCT/US13/48384-61/665,217—entitled Multipurpose Mass Spectrometric Assay Panels For Peptides

61/314,149, entitled MS Internal Standards at Clinical Levels filed on Mar. 15, 2010;

61/665,217, entitled Multipurpose Mass Spectrometric Assay Panels for Peptides filed on Jun. 27, 2012

60/415,499, entitled Monitor Peptide Enrichment Using Anti-Peptide Antibodies, filed 3 Oct 2002;

60/420,613, entitled Optimization of Monitor Peptide Enrichment Using Anti-Peptide Antibodies, filed 23 Oct. 2002;

60/449,190, entitled High Sensitivity Quantitation of Peptides by Mass Spectrometry, filed 20 Feb. 2003;

60/496,037, entitled Improved Quantitation of Peptides by Mass Spectrometry, filed 18 Aug. 2003;

60/557,261, entitled Selection of Antibodies and Peptides for Peptide Enrichment, filed 29 Mar. 2004;

61/314,154 entitled Stable Isotope Labeled Peptides on Carriers, filed 15 Mar. 2010;

61/314,149 entitled MS Internal Standards at Clinical Levels filed 15 Mar. 2010;

61/665,217 entitled Multipurpose Mass Spectrometric Assay Panels For Peptides filed 27 Jun. 2012;

61/665,228 entitled Simultaneous Peptide And Metabolite Affinity Capture Mass Spectrometry filed 27 Jun. 2012;

61/670,493 entitled Proteolytic Digestion Kit With Dried Reagents filed 11 Jul. 2012;

61/720,386 entitled Peptide Fragments Of Human Protein C Inhibitor And Human Pigment Epithelium-Derived Factor And Use In Monitoring Of Prostate Cancer filed 30 Oct. 2012;

62/137,560 Devices For Collection Of Blood In Dried Form, filed 24 Mar. 2015;

The following documents are incorporated by reference herein in their entirety:

Dried blood spot cards and devices of various types including:

Whatman 903 & DMPK cards made by GE Healthcare Life Sciences (and described at the website

http://www.gelifesciences.com/webapp/wcs/stores/servlet/CategoryDisplay?categoryId=104363&catalogId=10101&productId=&top=Y&storeId=11787&langId=-1).

AutoCollect made by Ahlstrom (and described at the website http://www.ahlstrom.com/en/Products/laboratory-and-life-science/life-science-specimen-collection/ahlstom-autocollect/).

Mitra made by Neoteryx (and described at the website www.neoteryx.com, and in patent documents EP 2 785 859, 2017/0023446, 2017/0043346, 2017/0128934, US2013/0116597).

hemaPEN made by Trajan Scientific and Medical (and described at the website http://www.trajanscimed.com/pages/hemapen, and in WO002017024360A1).

HemoLink made by Tasso, Inc. (and described at the website www.tassoinc.com, and in US2013/0211289 and US2014/0038306).

Capitainer made by Capitainer (and described at the website www.Capitainer.se).

Hemaxis made by DBS System SA (and described at the website http://hemaxis.com/services/).

TAP100 Touch Activated Phlebotomy made by 7th Sense Bio (and described at the website http://www.7sbio.com/about/, and in).

HemaSpot HF made by Spotonsciences (and described at the website http://www.spotonsciences.com/).

PTS Pod™ Blood Collection System made by PTS Diagnostics (and described at the website http://www.ptsdiagnostics.com/pts-pod-system.html).

Noviplex Plasma Prep Card made by Novilytic Laboratories (and described at the website https://novilytic.com/).

Advance Dx 100 plasma collection card made by Advance Dx, Inc. (and described at the website http://www.adx100.com/more_info.htm).

ViveBio plasma separation card made by ViveBio LLC (and described at the website http://www.vivebio.com/scientific_literature.html).

Asante Dried Blood Specimen Collection Strip made by Sedia Biosciences (and described at the website http://www.sediabio.com/products/blood-specimen-collection-devices).

Fluispotter made by Fluisense (and described at the website http://www.fluisense.com/).

Descriptions of the ViveST device contained in U.S. Pat. Nos. 7,638,099; 8,334,097; and 8,685,748; U.S. Design Pat. No. D631,169, and U.S. application Ser. Nos. 14/020,142 and 14/165,877

Descriptions of the “Mitra” absorber material in U.S. Pat. No. 7,638,099 and US20130116597

Calibrated capillary micropipettes (e.g., Drummond Scientific)

Matrix 2D Barcoded Storage Tubes (https://www.matrixtechcorp.com/storage-systems/tubes.aspx?id=63) and Fluidx 96-Well Format Sample Storage Tubes with Screw Cap and 2D Barcode (http://www.fluidx.eu/96-well-format-sample-storage-tubes-with-2d-barcode.html)

Various commercially available absorbable gelatin or collagen sponges such as SURGIFOAM® Absorbable Gelatin Sponges by Ethicon and GELFOAM Sterile Compressed Sponge made by Pfizer.

Formed zeolite tablets as described in U.S. Pat. No. 4,214,011.

Incorporated by reference herein in their entirety are the contents of each of the below patent documents:

| | Patent or |
|---|---|
| Category | Application |
| GenTegra | US20100209957 |
| GenTegra | US2014/0295429 |
| Hopfgartner | EP2484448A1 |
| Miscellaneous | CN203483432U |
| Miscellaneous | CN205002991U |
| Miscellaneous | CN205181357U |
| Miscellaneous | US 2003/0156996 |
| Miscellaneous | US 2013/0071944 |
| Miscellaneous | U.S. Pat. No. 6,274,304 |
| Miscellaneous | U.S. Pat. No. 6,582,290 |
| Miscellaneous | U.S. Pat. No. 7,638,099 |
| Miscellaneous | U.S. Pat. No. 8,685,748 |
| Miscellaneous | US20030178328 |
| Miscellaneous | US20030195435 |
| Miscellaneous | US20040265187 |
| Miscellaneous | US20050227269 |
| Miscellaneous | US20070208275 |
| Miscellaneous | US20130116597 |
| Miscellaneous | U.S. Pat. No. 4,214,011 |
| Miscellaneous | U.S. Pat. No. 5,520,041 |
| Miscellaneous | U.S. Pat. No. 5,665,238 |
| Miscellaneous | U.S. Pat. No. 5,747,265 |
| Miscellaneous | U.S. Pat. No. 6,036,659 |
| Miscellaneous | U.S. Pat. No. 6,106,732 |
| Miscellaneous | U.S. Pat. No. 6,524,533 |
| Miscellaneous | US20130211289_1 |
| Miscellaneous | US20140038306_2 |
| Neoteryx | EP 2 785 859 |
| Neoteryx | US 2017/0023446 |
| Neoteryx | US 2017/0043346 |
| Neoteryx | US 2017/0128934 |
| Neoteryx | US2013/0116597 |
| Seventh Sense Biosystems, Inc. | EP3243435A1 |
| Seventh Sense Biosystems, Inc. | JP2015211878A |
| Seventh Sense Biosystems, Inc. | US20100069726A1 |
| Seventh Sense Biosystems, Inc. | US20100249560A1 |
| Seventh Sense Biosystems, Inc. | US20100269837A1 |
| Seventh Sense Biosystems, Inc. | US20100272652A1 |
| Seventh Sense Biosystems, Inc. | US20100330703A1 |
| Seventh Sense Biosystems, Inc. | US20110009847A1 |
| Seventh Sense Biosystems, Inc. | US20110105872A1 |
| Seventh Sense Biosystems, Inc. | US20110105951A1 |
| Seventh Sense Biosystems, Inc. | US20110105952A1 |
| Seventh Sense Biosystems, Inc. | US20110172508A1 |
| Seventh Sense Biosystems, Inc. | US20110172510A1 |
| Seventh Sense Biosystems, Inc. | US20110181410A1 |
| Seventh Sense Biosystems, Inc. | US20120010529A1 |
| Seventh Sense Biosystems, Inc. | US20120016308A1 |
| Seventh Sense Biosystems, Inc. | US20120039809A1 |
| Seventh Sense Biosystems, Inc. | US20120041338A1 |
| Seventh Sense Biosystems, Inc. | US20120123297A1 |
| Seventh Sense Biosystems, Inc. | US20120271125A1 |
| Seventh Sense Biosystems, Inc. | US20120275955A1 |
| Seventh Sense Biosystems, Inc. | US20120277696A1 |
| Seventh Sense Biosystems, Inc. | US20120277697A1 |
| Seventh Sense Biosystems, Inc. | US20130158468A1 |
| Seventh Sense Biosystems, Inc. | US20130158482A1 |
| Seventh Sense Biosystems, Inc. | WO2011065972A2 |
| Seventh Sense Biosystems, Inc. | WO2016123282A1 |
| Trajan | WO002017024360 |
| Vivebio | US20140038172 |
| Vivebio | US20140141411 |
| Vivebio | U.S. Pat. No. 7,638,099 |
| Vivebio | USD631169 |
| Weighing blood for donation | US20040186408A1 |
| Weighing blood for donation | US20090081785A1 |
| Weighing blood for donation | U.S. Pat. No. 3,924,700 |
| Weighing blood for donation | U.S. Pat. No. 4,294,320 |
| Weighing blood for donation | U.S. Pat. No. 4,449,538 |
| Weighing blood for donation | U.S. Pat. No. 4,922,922 |
| Weighing blood for donation | U.S. Pat. No. 4,923,449 |
| Weighing blood for donation | U.S. Pat. No. 5,064,541 |
| Weighing blood for donation | U.S. Pat. No. 6,524,533 |

### FIELD AND BACKGROUND OF THE INVENTION

This invention relates to quantitative assays for evaluation of proteins and other analytes in complex samples such as human blood, urine, and cerebrospinal fluid, and specifically to the collection, transport, storage and preparation of samples for such assays.

There is a need for improvement in the collection and processing of liquid human samples, including whole blood, plasma, serum, urine, saliva and cerebrospinal fluid, for the measurement of disease-related proteins, metabolites, drugs, and nucleic acids (i.e., use in clinical diagnostics). Blood is a primary clinical specimen, and represents the largest and deepest version of the human proteome present in any sample: in addition to the classical “plasma proteins” and the cells of red cells, white cells and platelets, it contains all tissue proteins (as leakage markers) plus very numerous distinct immunoglobulin sequences; and it has an extraordinary dynamic range, in that more than 10 orders of magnitude in concentration separate albumin and the rarest proteins now measured clinically. Abundant scientific evidence, from proteomics and other disciplines, suggests that among these are proteins whose abundances and structures change in ways indicative of many, if not most, human diseases. Nevertheless, only about 100 proteins are currently used in routine clinical diagnosis, while the rate of introduction of new protein tests approved by the US FDA has paradoxically declined over the last decade to about one new protein diagnostic marker approved per year. Furthermore, it appears that the clinical value of most such tests would be substantially improved if the results were interpreted in terms of patient-specific (i.e., personalized) baselines (rather than population reference intervals)—an advance that is currently inhibited by the cost and inconvenience of collecting a series of baseline samples from each patient before the emergence of major disease processes. Major advances in diagnostics are to be expected if certain technical problems in sample collection, preparation and analysis are solved. In this specification, I focus on issues of the collection and preparation of suitable samples from blood, although the disclosed processes can be used for other sample types as well.

Human blood, and the serum and plasma samples derived from it, is typically collected and prepared in evacuated glass or plastic tubes (known colloquially as “Vacutainers”). In the usual course of medical practice, these tubes are filled by venipuncture and sent to a clinical laboratory for analysis, where they may be stored for extended periods (hours to days) at room temperature or 4 C. It would be useful to obtain small samples of blood by skin prick instead of venipuncture, thus allowing collection of blood samples for protein measurement by a patient at home, and to stabilize such samples in order to facilitate transport to an analytical laboratory.

Drying is one such method of stabilization applicable to blood. Based on Guthrie's implementation (1) of dried blood spots (DBS) on filter paper for newborn screening, dried samples have been investigated in a variety of contexts for a decade or more. Numerous publications have confirmed that a wide array of metabolites, drugs and proteins can be measured in such samples (2,3) and that individuals can perform effective finger prick sample collection at home (4). DBS samples are not fully equivalent to conventional venipuncture specimens in terms of accurately known plasma volume or concentration of some biomarkers (e.g., proteins elevated in interstitial fluid compared to venous blood), but these limitations can be largely overcome using new MS-based analytical methods.

Determining blood analyte concentrations from dried samples is complicated by the fact that concentrations of large analytes (such as proteins or circulating cells) can change significantly due to shifts in the distribution of water between the blood and other tissues. Albumin and total protein concentrations in blood can change by 5-10% over 30min depending on posture, whereas small analytes like sodium and potassium are hardly affected (9). In order to reduce this variation in samples acquired under field conditions (where control of patient posture before sample collection may not be rigorously controlled) it would be useful to be able to measure the amount of water in the blood sample in relation to the non-aqueous solutes and solids (cells, proteins, lipids, ions, etc.).

Mass spectrometric assays using DBS are especially attractive because by digesting the proteins to peptides, generally with trypsin, and then measuring surrogate peptides that are unique to each protein (“proteotypic peptides”) by mass spectrometry (MS), the problem of protein stability over time is alleviated. From the MS viewpoint, this approach has the effect of transforming the protein measurement problem into a small molecule quantitation problem, where isotope dilution methods are effective and well understood. However, high precision quantification of protein biomarkers in DBS samples remains challenging since most established MRM methods lack the sensitivity required to detect or measure many biomarkers in small sample sizes such as DBS.

The basic components for conventional dried blood spot collection are a lancet to pierce the skin and a paper blood collection card. Following a finger prick using a disposable lancet applied to a finger cleaned with an alcohol swab, the user attempts to apply blood to a collection card, for example a Whatman 903 card, typically attempting to place one drop of blood on each of the 5 circles on the card. After drying in air for at least 2 hours, the card may be folded closed and stored in a desiccated bag, ideally at 4 C or −20 C. Placement of the blood drops is difficult for many individuals as they must squeeze, or “milk” the punctured finger in order to extract sufficient blood while simultaneously steering the forming droplet (which is difficult to see since it hangs beneath the lanced finger) into a circle without actually touching the finger to the paper. The volumes of the drops produced and the size to which they spread is not well controlled, leading to variation in the amount of blood in a punch taken from the dried card for analysis. In addition, the components of clotting blood (plasma, cells and coagulum) may be differentially transported in the paper as the blood drop spreads out, leading to differences in composition at different points in the dried drop, further complicating measurement of true blood concentrations of biomarkers.

The conventional method of using DBS samples is to punch a small circle from a blood-containing region of the paper, typically about ¼ inch in diameter. Differences in amount of blood retained by that area of paper, in blood hematocrit (which affects viscosity and hence spreading), in coagulation and chromatography during drop spreading and in preferential drying near the edge of the blood-soaked region, all result in variations away from the bulk composition of a homogeneous applied blood sample. It would therefore be preferable to analyze a sample that represents the entirety of a volume of collected blood, rather than a potentially variable subset.

While dried blood spot cards can be barcoded and otherwise labeled effectively, when a punch is removed from the card, the identification of the sample must be transferred to the excised sample punch (which is typically not barcoded or otherwise labeled due to its small size and fibrous character) and subsequently to the vessel into which the punch is placed without error. It would therefore be preferable to avoid the movement of the sample out of its original identified format during processing, and in particular to avoid movement of the sample in any form that is not somehow labeled in an error-free manner.

To facilitate determination of analyte concentrations in terms of mass per volume of blood (or its serum, plasma or cellular constituents), it can be useful to collect and stabilize a pre-determined volume of blood, and to analyze all of this volume rather than a region of a potentially inhomogeneous spot.

In order to test for low-abundance biomarkers, it would also be beneficial to analyze samples larger than conventional ¼″ blood spot punches, which contain on average only about 14 ul of blood and 7 ul of plasma. While a single dried blood spot typically represents one drop, or about 25 ul, of blood, it is difficult to cut out the whole spot and introduce it into a vessel for extraction since the whole spot has a larger diameter than the diameter of a standard 96-well plate well (typically 6-8 mm).

While the conventional DBS collection procedure relies on drying the sample in ambient air, which can vary in humidity and temperature over a wide range, it would also be useful to provide means of drying the sample quickly and reproducibly to a very low humidity independent of ambient conditions.

For those analytical procedures that require digestion of the proteins to peptides (e.g., by exposure to a proteolytic enzyme such as trypsin), it would be useful to provide a means for executing this digestion conveniently and reproducibly on samples without the need to divide or transfer the sample to a secondary container.

The present invention addresses these problems by providing means for capillary blood collection, volume measurement and stabilization by drying in a device that facilitates automated processing of the entire sample once the sample arrives at the analytical laboratory without transfer to a secondary vessel early in the process. Reagents, such as synthetic stable-isotope labeled peptides used as internal standards for quantitation, can be incorporated into the sample collection device as well.

The invention is equally applicable to protein samples from sources other than blood, such as tissue homogenates, animal, plant or microbial samples, other body fluids, environmental samples and the like. While the device and methods are described mainly in terms of sample collection for protein analysis, other biomolecules, such as DNA and RNA, drugs or metabolites, as well as non-biological environmental chemicals can likewise be collected, processed and stabilized.

A general approach for protein biomarker quantitation involves digesting proteins (e.g., with trypsin) into peptides that can be further fragmented (MS/MS) in a mass spectrometer to generate a sequence-based identification. The approach can be used with either electrospray (ESI) or MALDI ionization, and is typically applied after one or more dimensions of chromatographic or affinity (e.g., SISCAPA) fractionation to reduce the complexity of peptides introduced into the MS at any given instant. Preparation of peptides from a sample such as plasma is typically carried out by first denaturing an aqueous protein sample (e.g., with detergents such as deoxycholate, organic solvents, urea or guanidine HCl), reducing the disulfide bonds in the proteins (e.g., with tris(2-carboxyethyl)phosphine (TCEP), dithiothreitol or mercaptoethanol), alkylating the cysteines (e.g., by addition of iodoacetamide which reacts with the free —SH group of cysteine), quenching excess iodoacetamide by addition of more dithiothreitol or mercaptoethanol, and finally (after removal or dilution of the denaturant) addition of the selected proteolytic enzyme (e.g. trypsin), followed by incubation to allow digestion. Following incubation, the action of trypsin is terminated, either by addition of a chemical inhibitor (e.g., TLCK) or by denaturation (through heat or addition of denaturants, or both) or removal (if the trypsin is on a solid support) of the trypsin.

SISCAPA assays (5,6) combine affinity enrichment of specific peptides with quantitative measurement of those peptides by mass spectrometry. In order to detect and quantitatively measure protein analytes, the SISCAPA technology makes use of anti-peptide antibodies (or any other binding entity that can reversibly bind a specific peptide sequence of about 5-20 residues) to capture specific peptides from a mixture of peptides, such as that arising, for example, from the specific cleavage of a protein mixture (like human serum or a tissue lysate) by a proteolytic enzyme such as trypsin or a chemical reagent such as cyanogen bromide. By capturing a specific peptide through binding to an antibody (the antibody being typically coupled to a solid support either before or after peptide binding), followed by washing of the antibody:peptide complex to remove unbound peptides, and finally elution of the bound peptide into a small volume (typically achieved by an acid solution such as 5% acetic acid), the SISCAPA technology makes it possible to enrich specific peptides that may be present at low concentrations in the whole digest, and therefore undetectable in simple mass spectrometry (MS) or liquid chromatography-MS (LC/MS) systems against the background of more abundant peptides present in the mixture. It also provides a sample that is less complex, and therefore exhibits lesser ‘matrix effects’ and fewer analytical interferences, than observed in the starting digest. This in turn permits mass spectrometry analysis without further separation steps, although additional separation processes could be used if desired. The sample can be concentrated prior to analysis if necessary, but this concentration does not provide any further analyte peptide separation. This enrichment step is intended to capture peptides of high, medium or low abundance and present them for MS analysis: it therefore discards information as to the relative abundance of a peptide in the starting mixture in order to boost detection sensitivity. This abundance information, which is of great value in the fields of proteomics and diagnostics, can be recovered, however, through the use of isotope dilution methods: the SISCAPA technology makes use of such methods (e.g., by using stable isotope labeled versions of target peptides) in combination with specific peptide enrichment, to provide a method for quantitative analysis of peptides, including low-abundance peptides. The approach to standardization in SISCAPA is to create a version of the peptide to be measured which incorporates one or more stable isotopes of mass different from the predominant natural isotope, thus forming a labeled peptide variant that is chemically identical (or nearly-identical) to the natural peptide present in the mixture, but which is nevertheless distinguishable by a mass spectrometer because of its altered peptide mass due to the isotopic label(s). In one embodiment, the method for creating the labeled peptide is chemical synthesis, wherein a peptide with chemical structure identical to the natural analyte can be made while incorporating amino acid precursors that contain heavy isotopes of hydrogen, carbon, oxygen or nitrogen (e.g., 3H, 13C, 18O or 15N) to introduce the isotopic label. In theory one could also use radioactive (i.e., unstable) isotopes (such as 3H), but this is less attractive for safety reasons. The isotopic peptide variant (a Stable Isotope-labeled Standard, or SIS) is used as an internal standard and is added to the sample peptide mixture at a known concentration before enrichment by antibody capture. The antibody captures and enriches both the natural and the labeled peptide together (having no differential affinity for either) according to their relative abundances in the sample. Since the labeled peptide is added at a known concentration, the ratio between the amounts of the natural and labeled forms detected by the final MS analysis allows the concentration of the natural peptide in the sample mixture to be calculated. Thus, the SISCAPA technology makes it possible to measure the quantity of a peptide of low abundance in a complex mixture, and since the peptide is typically produced by quantitative (complete) cleavage of sample proteins, the abundance of the parent protein in the mixture of proteins can be deduced. The SISCAPA technology can be multiplexed to cover multiple peptides measured in parallel, and can be automated through computer control to afford a general system for protein measurement. Creating a new protein-specific assay thus, requires only that a peptide-specific antibody and a labeled peptide analog be created. A feature of the SISCAPA technology is directed at establishing quantitative assays for specific proteins selected a priori, rather than at the problem of comparing all of the unknown components of two or more samples to one another. It is this focus on specific assays that makes it attractive to generate specific antibodies to each monitor peptide (in principle one antibody binding one peptide for each assay).

The SISCAPA method, including prior sample digestion, has recently been fully automated using conventional robotic liquid handling systems acting on samples in 96 well plates (7). The introduction of dried blood spot samples into such 96 well plates remains however only partially automated (e.g., using the PerkinElmer Panthera-Puncher 9) which punches small circular regions of the DBS card (typically ¼″ diameter) into designated wells guided by an operator holding the card. Variations in the blood content of the punched region, or its composition relative to the applied blood, result in analytical error.

In the descriptions that follow, quantitation of proteins, peptides and other biomolecules is addressed in a general sense, and hence the invention disclosed is in no way limited to the analysis of blood, plasma and other body fluids. The instant invention uses several of the cited methods of the prior art in an entirely different combination.

### SUMMARY OF THE INVENTION

The present invention relates to devices and methods for collecting, stabilizing and further processing biological samples including blood. The invention allows a volume of blood to be introduced into a container, and dried by a desiccant in a closed space isolated from the variable humidity of the external atmosphere. The invention allows collection and processing of larger amounts of blood (20-150 μl or more) than are conveniently recovered and processed using conventional dried blood spots on filter paper. The invention provides for verification of the amount of sample collected by means of weight measurements on a dried sample and/or sample water extracted by a weighed desiccant. The invention allows collected samples to be directly interfaced with laboratory robotic sample handling technology without manual intervention. Samples collected according to the invention are identified by unique machine-readable codes to establish a chain of custody from collection to analysis. Sample collection according to the invention can be carried out under the control of mobile computing devices (e.g., smartphones) capable of assisting the user and adding important information (e.g., GPS location) to a sample-associated record transmitted to and stored in the cloud.

A summary of the invention further includes:
1. A dried sample collection device, wherein the sample vessel has dimensions compatible with placement in a standard 96 well format.
2. The device of any of 1, further comprising a guide cap reversibly joinable with the sample vessel, the guide cap comprising an opening for the movable insertion of a sample applicator into contact with the sample absorber.
3. The device of any of 1-2, further comprising a sample applicator having a volume determining interior, an opening for the introduction of liquid sample and the same or a different opening for contacting sample with the sample absorber.
4. The device of any of 1-3, wherein, prior to the application of sample, the sample absorber comprises one or more of the following reagents: protein denaturants, detergents, sulfhydryl reductants, or buffers.
5. A device, wherein, prior to the application of sample, the sample absorber comprises one or more dried internal standard molecules.
6. The device of any of 1-5, further comprising an air circulator component capable of actively moving air within the assembled sample and desiccant vessels.
7. The device of any of 1-6, further comprising one or more electronic devices measuring, recording and/or communicating one or more of the following data: temperature, humidity, and GPS position.
8. An analytical standard, comprising the sample collection device of any of 1-7 and a measured quantity of a standard biological sample dried within it.
9. A method for determining an amount of an analyte in a sample, comprising dissolving sample dried in or on the sample absorber in the sample collection device of any of 1-8 and analyzing the amount of one or more desired analytes in the dissolved sample.
10. The method of 9, further comprising placing the sample vessel in a 96 well format array.
11. The method of 9 or 10, wherein the analysis includes determination of the amounts of said one or more analytes by mass spectrometry.
12. The method of 11, wherein the analysis includes protein denaturation, proteolytic digestion, and enrichment of preselected peptide analytes.
13. The method of 11 or 12, wherein a stable isotope labeled analyte is used in the analysis as an internal standard for mass spectrometric quantitation.
14. The method of any of 12-13, wherein a stable isotope labeled analyte is placed on the sample absorber and dried before contacting of sample with the sample absorber.
15. The method of any of 10-14, wherein tare weights of the sample vessel, the associated desiccant vessel or a combination of the two are recorded prior to contacting of sample to the device.
16. A sample collection device, comprising a water-insoluble solid desiccant shaped to contain a volume of liquid sample in contact with the desiccant and comprising a quantity of desiccant sufficient to bind an amount of water at least equal to the amount of water contained in the sample.
17. The device of 16, wherein the desiccant forms a capillary tube for introduction of sample.
18. The device of 16 or 17, wherein the capillary tube comprises a movable plug or plunger for expelling dried sample.
19. A device, wherein the device is labeled with a machine or human readable identification.
20. A device, wherein, the desiccant comprises molecular sieve material.
21. A device, wherein the desiccant comprises zeolite.
22. The device of any of 16-21, wherein external surfaces of the desiccant are coated with a stabilizing and/or water resistant coating.
23. A method for the determination of an amount of an analyte in a sample, comprising dissolving sample dried on the desiccant of the sample collection device of any of 16-22 and analyzing the amount of one or more desired analytes in the dissolved sample.
24. The method of 23, wherein the analysis includes determination of the amounts of said one or more analytes by mass spectrometry.
25. The method of any of 23-24, wherein the analysis includes protein denaturation, proteolytic digestion, and enrichment of preselected peptide analytes.
26. The method of any of 24-25, wherein a stable isotope labeled analyte is used in the analysis as an internal standard for mass spectrometric quantitation.
27. The method of any of 23-26, wherein tare weights of the desiccant and/or the device are recorded prior to contacting of sample to the device.
28. A sample collection assistance device, comprising an attachment port having an opening for attachment to a sample collection device and reversibly joinable to form a tight seal with a sample collection device, a mobile computing device camera to capture images of a user collecting a sample to provide positive user identification, a vacuum pump, an internal channel connecting the vacuum pump and the attachment port and a release valve, when open, connecting the vacuum pump to outside air.
29. A method for collecting sample relevant data, comprising attaching a sample collection device and a mobile computing device to the sample collection assistance device of 28 and collecting sample relevant data in the mobile computing device.
30. A method for collecting data relevant to a sample, comprising receiving a transmission of data from a sample collection assistance device, comprising an attachment port having an opening for attachment to a sample collection device and the port reversibly joinable to form a tight seal with a sample collection device, an angled mirror configured to align with a mobile computing device camera to capture images of a user collecting a sample to provide positive user identification, a vacuum pump, an internal channel connecting the vacuum pump and the attachment port and a release valve, when open, connecting the vacuum pump to outside air and/or receiving a transmission of sample relevant data from a mobile computing device connected thereto.
31. A device in which a sample collection capillary is formed from a water-permeable material such as paper, which may be optionally coated with a coating of water-soluble material that renders the tube walls impermeable until said material dissolves in a sample.

A summary of the invention further includes:

1. A sample collection device, comprising a sample vessel and a desiccant vessel, the two vessels being reversibly joinable to form a tight seal, wherein the sample vessel comprises a sample absorber and the desiccant vessel comprises a quantity of desiccant sufficient to bind an amount of water at least equal to the amount of water contained in an imbibed sample, and wherein the sample vessel optionally comprises at least one unique computer-readable code.
2. The device of 1, wherein the sample vessel has dimensions compatible with placement in a standard 96 well format.
3. The device of any of 1 or 2, further comprising a guide cap reversibly joinable with the sample vessel, the guide cap comprising an opening for the movable insertion of a sample applicator into contact with the sample absorber.
4. The device of any of 1-3, further comprising a sample applicator having a volume determining interior, an opening for the introduction of liquid sample and the same or a different opening for contacting sample with the sample absorber.
5. The device of any of 1-4, wherein, prior to the application of sample, the sample absorber comprises one or more of the following reagents: protein denaturants, detergents, sulfhydryl reductants, or buffers.
6. The device of any of 1-5, wherein, prior to the application of sample, the sample absorber comprises one or more dried internal standard molecules.
7. The device of any of 1-6, further comprising an air circulator component capable of actively moving air within the assembled sample and desiccant vessels.
8. The device of any of 1-7, further comprising one or more electronic devices measuring, recording and/or communicating one or more of the following data: temperature, humidity, and GPS position.
9. An analytical standard, comprising the sample collection device of any of 1-8 and a measured quantity of a standard biological sample dried within it.
10. A method for determining an amount of an analyte in a sample, comprising dissolving sample dried in or on the sample absorber in the sample collection device of any of 1-8 and analyzing the amount of one or more desired analytes in the dissolved sample.
11. The method of 10, further comprising placing the sample vessel in a 96 well format array.
12. The method of 10 or 11, wherein the analysis includes determination of the amounts of said one or more analytes by mass spectrometry.
13. The method of 12, wherein the analysis includes protein denaturation, proteolytic digestion, and enrichment of preselected peptide analytes.
14. The method of 12 or 13, wherein a stable isotope labeled analyte is used in the analysis as an internal standard for mass spectrometric quantitation.
15. The method of any of 12-13, wherein a stable isotope labeled analyte is placed on the sample absorber and dried before contacting of sample with the sample absorber.
16. The method of any of 10-15, wherein tare weights of the sample vessel, the associated desiccant vessel or a combination of the two are recorded prior to contacting of sample to the device.
17. A sample collection device, comprising a water-insoluble solid desiccant shaped to contain a volume of liquid sample in contact with the desiccant and comprising a quantity of desiccant sufficient to bind an amount of water at least equal to the amount of water contained in the sample.
18. The device of 17, wherein the desiccant forms a capillary tube for introduction of sample.
19. The device of 17 or 18, wherein the capillary tube comprises a movable plug or plunger for expelling dried sample.
20. The device of any of 17-19, wherein the device is labeled with a machine or human readable identification.
21. The device of any of 17-20, wherein the desiccant comprises molecular sieve material.
22. The device of any of 17-21, wherein the desiccant comprises zeolite.
23. The device of any of 17-22, wherein external surfaces of the desiccant are coated with a stabilizing and/or water resistant coating.
24. A method for the determination of an amount of an analyte in a sample, comprising dissolving sample dried on the desiccant of the sample collection device of any of 17-22 and analyzing the amount of one or more desired analytes in the dissolved sample.
25. The method of 24, wherein the analysis includes determination of the amounts of said one or more analytes by mass spectrometry.
26. The method of 25, wherein the analysis includes protein denaturation, proteolytic digestion, and enrichment of preselected peptide analytes.
27. The method of 25 or 26, wherein a stable isotope labeled analyte is used in the analysis as an internal standard for mass spectrometric quantitation.
28. The method of any of 24-27, wherein tare weights of the desiccant and/or the device are recorded prior to contacting of sample to the device.
29. A sample collection assistance device, comprising an attachment port having an opening for attachment to a sample collection device and reversibly joinable to form a tight seal with a sample collection device, a mobile computing device camera to capture images of a user collecting a sample to provide positive user identification, a vacuum pump, an internal channel connecting the vacuum pump and the attachment port and a release valve, when open, connecting the vacuum pump to outside air.
30. A method for collecting sample relevant data, comprising attaching a sample collection device and a mobile computing device to the sample collection assistance device of 29 and collecting sample relevant data in the mobile computing device.
31. A method for collecting data relevant to a sample, comprising receiving a transmission of data from a sample collection assistance device, comprising an attachment port having an opening for attachment to a sample collection device and the port reversibly joinable to form a tight seal with a sample collection device, optionally an angled mirror configured to align with a mobile computing device camera to capture images of a user collecting a sample to provide positive user identification, a vacuum pump, an internal channel connecting the vacuum pump and the attachment port and a release valve, when open, connecting the vacuum pump to outside air and/or receiving a transmission of sample relevant data from a mobile computing device connected thereto.
32. A sample collection device, comprising a container made of water-insoluble but water permeable material in a form into which a volume of sample can be loaded by capillary action, and from which water is extracted by evaporation through the walls of said container.
33. The device of 32 in which the container is a tube made by helical winding a strip of paper or paper-like material, or by molding or extrusion of a porous material..
34. The device of any of 32-33 in which a quantity of solid desiccant sufficient to bind an amount of water at least equal to the amount of water contained in the sample is placed in proximity to the collection device.
35. A method using the device of any of 32-34 in which the collection device comprising the permeable sample container and the desiccant, including any desiccant packaging, is weighed before and after loading of the device with sample, the difference between said weights providing a precise measure of the amount of sample loaded.
36. The method of 35 further including measurement of the permeable sample container before sample loading and after the sample dries as a result of water transfer to the desiccant, the difference between said weights providing a precise measure of the amount of dry solids in the sample loaded.
37. The method of any of 35-36 wherein measurement of the desiccant, including any desiccant packaging, before sample loading and after the sample dries as a result of water transfer to the desiccant, yields as the difference between said weights a precise measure of the amount of water extracted from the sample loaded.
38. The methods of any of 35-37 further including the use of the dry solids, water and total sample weights to provide an amount of sample, a total solute amount in a sample, a total volume of a sample, a measure of the blood dilution, or a measure of blood hematocrit.
39. A method, wherein tare weights of the sample vessel, the associated desiccant vessel, or a combination of the two, of any of 1-8 or 32-34 are recorded prior to contacting of sample to the device and subtracted from respective weights after loading and drying of a sample to yield a sample's dry solids and/or water weight.
40. The method of 39, wherein the amount or concentration of an analyte determined in a sample is normalized using the sample's measured dry weight or water weight.
41. The method of any of 39-40, wherein the amount or concentration of an analyte determined in a sample is normalized using the sample's measured dry weight or water weight after correction for residual water remaining in the dried sample.
42. The method of any of 39-41, wherein the amount or concentration of an analyte determined in a blood sample is normalized using the sample's measured dry weight or water weight, and an estimate of the blood sample's hematocrit.
43. The method of any of 39-42, wherein the amount of sample, or of a component of a sample, estimated using a sample's total, dry, or water weights, is evaluated to determine whether or not the amount of sample is adequate to accurately allow measurement of an analyte.
44. A method wherein the permeable sample container and desiccant, including any desiccant packaging, of the collection device of any of 32-34 each has a predetermined weight prior to loading with sample and wherein the collection device is provided loaded with sample and the sample dried, the method comprising, weighing the provided collection device, wherein the difference between the weight measured from said weighing and the predetermined weight yields a precise measure of the amount of sample loaded.
45. The method of 44, wherein the difference between the predetermined weight of the permeable sample container and the weight measured from said weighing of the dried loaded permeable sample container yields a precise measure of the amount of dry solids in the sample loaded.
46. The method of any of 44-45 wherein the difference between the predetermined weight of the desiccant, including any desiccant packaging, and the weight measured from said weighing of the provided desiccant yields a precise measure of the amount of water extracted from the sample loaded.
47. The method of any of 44-46 further including the use of dry solids, water and total sample weights to provide an amount of sample, a total solute amount in a sample, a total volume of a sample, a measure of the blood dilution, or a measure of blood hematocrit.
48. A method, wherein tare weights of the sample vessel, the associated desiccant vessel or a combination of the two of any of 1-8 are predetermined prior to contacting of sample to the device, wherein the device is provided loaded with sample and dried, wherein the method comprises weighing the provided device, the difference of the weights yielding the sample's dried solids and/or water weight.
49. The method of 48, wherein the amount or concentration of an analyte determined in a sample is normalized using the sample's measured dry solid weight or water weight.
50. The method of any of 48-49, wherein the amount or concentration of an analyte determined in a sample is normalized using the sample's measured dry solid weight or water weight after correction for residual water remaining in the dried sample.
51. The method of any of 48-50, wherein the amount or concentration of an analyte determined in a blood sample is normalized using the sample's measured dry solid weight or water weight, and an estimate of the blood sample's hematocrit.
52. The method of any of 48-51, wherein the amount of sample, or of a component of a sample, estimated using a sample's total, dry solid, or water weights, is evaluated to determine whether or not the amount of sample is adequate to accurately allow measurement of an analyte.
53. A plurality of devices of any of 1-8, 17-23 and 32-34, wherein the devices are assembled together and the weight of each device is within 1 milligram of each other of said devices.
54. The plurality of devices of 53, wherein the plurality of devices is two or more devices.
55. The plurality of devices of any of 53-54, wherein the plurality of devices is 10 or more devices.
56. The plurality of devices of any of 53-55, wherein the plurality of devices is 100 or more devices.
57. The plurality of devices of any of 53-56, wherein the weight of each device is within 0.5 milligrams of each other of said devices.
58. A sample collection device, comprising a sample absorber containing an internal capillary channel through which sample can flow, a rigid sample carrier by which the sample absorber can be manipulated without contacting the absorber, a desiccant, and a gas-impermeable housing with one or more closable openings, wherein the desiccant vessel comprises a quantity of desiccant sufficient to bind an amount of water at least equal to the amount of water contained in an imbibed sample, and wherein the sample carrier optionally comprises at least one unique computer-readable code.
A method of manufacturing a laminated sample collection device comprising a sandwich of sample carrier between two sheets of sample absorber, and wherein the sample carrier has an internal slot which, in said sandwich, creates a capillary channel facilitating flow of sample into the device.

A summary of the invention further includes:
1. A sample collection device, comprising a sample vessel and a desiccant vessel, the two vessels being reversibly joinable to form a tight seal, wherein the sample vessel comprises a sample absorber and the desiccant vessel comprises a quantity of desiccant sufficient to bind an amount of water at least equal to the amount of water contained in an imbibed sample, and wherein the sample vessel optionally comprises at least one unique computer-readable code.
2. A sample collection device, comprising a water-insoluble solid desiccant shaped to contain a volume of liquid sample in contact with the desiccant and comprising a quantity of desiccant sufficient to bind an amount of water at least equal to the amount of water contained in the sample.
3. A sample collection device, comprising a container made of water-insoluble but water permeable material in a form into which a volume of sample can be loaded by capillary action, and from which water is extracted by evaporation through the walls of said container.
4. The device of 3 in which the container is a tube made by helical winding a strip of paper or paper-like material, or by molding or extrusion of a porous material.
5. A sample collection device, comprising a sample absorber containing an internal capillary channel through which sample can flow, a rigid sample carrier by which the sample absorber can be manipulated without contacting the absorber, a desiccant, and a water-impermeable housing with one or more closable openings, wherein the desiccant vessel comprises a quantity of desiccant sufficient to bind an amount of water at least equal to the amount of water contained in an imbibed sample, and wherein the sample carrier optionally comprises at least one unique computer-readable code.
6. A laminated sample collection device comprising a sandwich of a rigid sample carrier between two sheets of sample absorber, wherein the sample carrier comprises at least one unique computer-readable code and wherein the sample carrier has an internal slot which, in said sandwich, creates a capillary channel facilitating flow of sample into the device.
7. The device of any of 1-6, wherein, prior to the application of sample, the sample absorber comprises one or more of the following reagents: protein denaturants, detergents, sulfhydryl reductants, or buffers.
8. The device of any of 1-7, wherein, prior to the application of sample, the sample absorber comprises one or more dried internal standard molecules.
9. The device of any of 1-8, further comprising an air circulator component capable of actively moving air within the assembled sample and desiccant vessels.
10. The device of any of 1-9, further comprising one or more electronic devices measuring, recording and/or communicating one or more of the following data: temperature, humidity, and GPS position.
11. An analytical standard, comprising the sample collection device of any of 1-6 and a measured quantity of a standard biological sample dried within it.
12. A method for determining an amount of an analyte in a sample, comprising dissolving sample dried in or on the sample absorber in the sample collection device of any of 1-11 and analyzing the amount of one or more desired analytes in the dissolved sample.
13. The method of 12, further comprising placing the sample vessel in a 96 well format array.
14. The method of 12, wherein the analysis includes determination of the amounts of said one or more analytes by mass spectrometry.
15. The method of 12, wherein the analysis includes protein denaturation, proteolytic digestion, and enrichment of preselected peptide analytes.
16. The method of 12-15, wherein a stable isotope labeled analyte is used in the analysis as an internal standard for mass spectrometric quantitation.
17. The method of any of 12-16, wherein a stable isotope labeled analyte is placed on the sample absorber and dried before contacting of sample with the sample absorber.
18. The method of any of 12-17, wherein tare weights of the sample vessel, the associated desiccant vessel or a combination of the two are recorded prior to contacting of sample to the device.
19. The device of any of 1-10, wherein the device is labeled with a machine or human readable identification.
20. The device of any of 1-10, wherein the desiccant comprises molecular sieve material.
21. The device of 20, wherein the desiccant comprises zeolite.
22. A method, wherein tare weights of the sample vessel, the associated desiccant vessel, or a combination of the two, of any of 1-21 are recorded prior to contacting of sample to the device and subtracted from respective weights after loading and drying of a sample to yield a sample's dry solids and/or water weight.
23. The method of 22, wherein the amount or concentration of an analyte determined in a sample is normalized using the sample's measured dry weight or water weight.
24. The method of any of 22-23, wherein the amount or concentration of an analyte determined in a sample is normalized using the sample's measured dry weight or water weight after correction for residual water remaining in the dried sample.
25. The method of any of 22-24, wherein the amount or concentration of an analyte determined in a blood sample is normalized using the sample's measured dry weight or water weight, and an estimate of the blood sample's hematocrit.
26. The method of any of 22-25, wherein the amount of sample, or of a component of a sample, estimated using a sample's total, dry, or water weights, is evaluated to determine whether or not the amount of sample is adequate to accurately allow measurement of an analyte.
27. A plurality of devices of any of 1-8, 17-23 and 32-34, wherein the devices are assembled together and the weight of each device is within 1 milligram of each other of said devices.
28. The plurality of devices of 27, wherein the plurality of devices is two or more devices.
29. The plurality of devices of any of 27-28, wherein the plurality of devices is 10 or more devices.
30. The plurality of devices of any of 27-29, wherein the plurality of devices is 100 or more devices.
31. The plurality of devices of any of 27-30, wherein the weight of each device is within 0.5 milligrams of each other of said devices.
32. Any of the above devices or methods employed to measure a biological sample used in the following method: a method for quantifying the amount of a protein in a bodily fluid, comprising: contacting a sample comprising a proteolytic digest of said bodily fluid and a labeled reference peptide with an anti-peptide antibody, wherein said anti-peptide antibody specifically binds a preselected peptide in said digest and said reference peptide; separating peptides bound by said antibody from unbound peptides, eluting peptides bound by said antibody from said antibody; measuring by mass spectrometry the amount of said preselected peptide and said reference peptide eluted from said antibody; and calculating the amount of said protein in said bodily fluid.
33. Any of the above devices or methods employed to measure a biological sample, wherein the measuring of the biological sample is made according to any of the methods described in U.S. Pat. No. 7,632,686, which as stated above, is incorporated herein in its entirety.

A summary of the invention further includes:
1. A sample collection device, comprising a sample vessel comprising a sample absorber and optionally a desiccant vessel, the two vessels being reversibly joinable to each other or to the device, wherein the sample vessel comprises a sample absorber and the desiccant vessel comprises a quantity of desiccant sufficient to bind an amount of water at least equal to the amount of water contained in an imbibed sample, and wherein one or more, or any combination of: the device, sample vessel, sample absorber, or desiccant vessel comprises (a) at least one computer-readable code and (b) a predetermined weight to a precision of plus or minus 0.5 milligrams.
2. The device of 1, wherein the sample absorber comprises an internal capillary channel through which sample can flow, a rigid sample carrier by which the sample absorber can be manipulated without contacting the absorber, and optionally a desiccant, and a water-impermeable housing with one or more closable openings, wherein the desiccant vessel comprises a quantity of desiccant sufficient to bind an amount of water at least equal to the amount of water contained in an imbibed sample, and wherein the sample carrier optionally comprises at least one unique computer-readable code.
3. The device of 1, wherein the sample absorber comprises a sandwich of a rigid sample carrier between two sheets of the sample absorber, wherein the sample carrier comprises at least one unique computer-readable code and wherein the sample carrier has an internal slot which, in said sandwich, creates a capillary channel facilitating flow of sample into the device.
4. The device of 1, having a predetermined weight to a precision of plus or minus 1.0 milligrams.
5. The device of 1, wherein the sample absorber is configured to be introduced into 96 well format array for operation in an automated sample processing.
6. A plurality of two or more devices of 1, wherein the weight of each device is within 1.0 milligram of a predetermined weight.
7. The plurality of devices of 6, wherein the weight of each device is within 0.5 milligrams of a predetermined weight.
8. The plurality of devices of 6, wherein the plurality of devices is 100 or more devices.
9. A method for determining an amount of an analyte in a sample, comprising dissolving sample dried in or on the sample absorber in the sample collection device of 1 and analyzing the amount of one or more desired analytes in the dissolved sample.
10. The method of 9, further comprising placing the sample absorber or the sample vessel in a 96 well format array.
11. The method of 9, wherein the analysis includes determination of the amounts of said one or more analytes by mass spectrometry.
12. The method of 9, wherein the analysis includes protein denaturation, proteolytic digestion, and enrichment of preselected peptide analytes.
13. The method of 9, wherein a stable isotope labeled analyte is used in the analysis as an internal standard for mass spectrometric quantitation.
14. The method of 9, wherein a stable isotope labeled analyte is placed on the sample absorber and dried before contacting of sample with the sample absorber.
15. The method of 9, wherein tare weights of any one of, or any combination of: the device, the sample vessel, the sample absorber, the desiccant vessel are recorded prior to contacting of sample thereto.
16. The method of 15, wherein the tare weights recorded prior to contacting of are subtracted from respective weights after loading and drying of a sample to yield a sample's dry solids and/or water weight.
17. The method of 16, wherein the amount or concentration of an analyte determined in a sample is normalized using the sample's measured dry weight or water weight.
18. The method of 16, wherein the amount or concentration of an analyte determined in a sample is normalized using the sample's measured dry weight or water weight after correction for residual water remaining in the dried sample.
19. The method of 16, wherein the amount or concentration of an analyte determined in a blood sample is normalized using the sample's measured dry weight or water weight, and an estimate of the blood sample's hematocrit.
20. The method of 16, wherein the amount of sample, or of a component of a sample, estimated using a sample's total, dry, or water weights, is evaluated to determine whether or not the amount of sample is adequate to accurately allow measurement of an analyte.

### BRIEF DESCRIPTION OF THE DRAWINGS:

FIG. 1. Device for collection of a predetermined volume of blood and drying the blood to a stable sample after collection.

FIG. 2. Steps in the use of the device of FIG. 1.

FIG. 3. Version of the device in which the sample applicator capillary and a formed tablet of desiccant are fixed in the desiccant lid.

FIG. 4. Version of the device comprising a sample vessel, separate desiccant container, and air circulator cap.

FIG. 5. A sampling device consisting of a mass of desiccant with a cavity for loading sample.

FIG. 6. A sampling device consisting of a slug of desiccant with a volume-determining sample hole, and a movable plug in the hole.

FIG. 7. A device capable of holding a slug of desiccant with a volume-determining sample hole, and filling the hole with sample by applying a slight vacuum under control of an attached smartphone, which also records the slug's identifying code and takes a photograph of the user to document the sample collection process.

FIG. 8. Aspects of a device in which a sample collection capillary is formed of permeable paper.

FIG. 9. Drawing of a device for drying sample in a water permeable capillary: End view and side view.

FIG. 10. Example of a device in which a sample collection capillary is formed of permeable paper.

FIG. 11. Example of a device in which the sample absorber and the desiccant are juxtaposed in a planar arrangement.

FIG. 12. Example of a device in which the sample absorber and the desiccant are juxtaposed in a planar arrangement, and placed within a structure that facilitates skin puncture by a lancet and production of a vacuum to assist in blood expression from the skin.

FIG. 13. Versions of devices in which the sample is imbibed into a tube of porous material and later dried through evaporation of water through the walls of the porous tube.

FIG. 14. Version of devices in which the sample is imbibed into one or more layers of porous material mounted on a rigid carrier strip and later dried through evaporation of water.

FIG. 15. Further arrangements of sample carriers and desiccant materials.

FIG. 16. Methods of manufacturing a planar sample carrier by lamination.

FIG. 17. A version of a planar sample carrier made by lamination, and designed to fit into a well of a 96-well plate.

FIG. 18. Design of a planar sample carrier and an accompanying desiccant carrier.

FIG. 19. Design of a housing for the sample and desiccant carriers of FIG. 19.

FIG. 20. Design of a housing for the sample carrier and desiccant tablets.

FIG. 21. Placement of a sample carrier like that of FIG. 18 or 19 into a 96-well plate well for processing, and use of a positioning plate to guide insertion and allow bulk removal of sample carriers into the plate.

### DETAILED DESCRIPTION OF THE INVENTION:

The invention provides devices and associated methods for collecting and stabilizing protein-containing samples for identification and quantitative analysis of peptides and/or proteins, metabolites, drugs, DNA and RNA therein. While many of the devices and methods known in the art and disclosed above are useful with the methods of the invention, the process for such a commercially useful process has not previously been disclosed.

The term “air circulator” means a device capable of causing movement of air within a closed container, and used for example to move air over sample in an imbibing zone and over a desiccant so as to accelerate drying of the sample. The air circulator may be internally powered (e.g., a propeller or fan driven by an electric motor powered by a battery, or a propeller or fan driven by a wound spring), or it may be externally powered (e.g., an internal propeller or fan driven by a magnet or magnetically responsive material interacting with an externally applied rotating or oscillating magnetic field, or driven by wobbling the vessel so as to rotate or oscillate an eccentric internal mass). Any device that causes air to circulate within the vessel or accelerate drying of sample in the imbibing zone can function as an air circulator.

The terms “analyte”, and “ligand” may be any of a variety of different molecules, or components, pieces, fragments or sections of different molecules that one desires to measure or quantitate in a sample. The term “monitor fragment” may mean any piece of an analyte up to and including the whole analyte, which can be produced by a reproducible fragmentation process (or without a fragmentation if the monitor fragment is the whole analyte) and whose abundance or concentration can be used as a surrogate for the abundance or concentration of the analyte. The term “monitor peptide” means a peptide chosen as a monitor fragment of a protein or peptide.

The term “biomolecules” refers to any molecule present in a biological system, and includes proteins, nucleic acids (specifically DNA and RNA in its various forms, both intracellular and extracellular), complex sugars (glycans and the like), lipids, and a variety of metabolites.

The term “capillary” refers to a material component having an internal cavity with internal wall surfaces sufficiently hydrophilic and cross-sectional dimensions sufficiently small so as to cause aqueous solutions (including blood) to be drawn into the cavity by capillary forces. In its simplest form a capillary may be a tube made of glass, but the term also includes non-cylindrical forms (e.g., gaps between opposing flat surfaces), as well as water- and/or analyte-permeable materials such as paper, or various polymers.

The terms “proteolytic treatment” or “enzyme” may refer any of a large number of different enzymes, including trypsin, chymotrypsin, lys-C, v8 and the like, as well as chemicals, such as cyanogen bromide. In this context, a proteolytic treatment acts to cleave peptide bonds in a protein or peptide in a sequence-specific manner, generating a collection of peptide fragments referred to as a digest.

The term “denaturant” includes a range of chaotropic and other chemical agents that act to disrupt or loosen the 3-D structure of proteins and other complex molecules without breaking covalent bonds, thereby rendering them more susceptible to proteolytic treatment, more soluble, or both. Examples include chaotropes such as urea, guanidine hydrochloride, ammonium thiocyanate; detergents such as sodium dodecyl sulfate, cetyltrimethyl ammonium bromide, Triton X-100; as well as solvents such as acetonitrile, ethanol, methanol and the like.

The term “desiccant” means a material capable of binding water and removing it from the air, so as to lower humidity, or directly from a contacting liquid. Desiccants include silica gel, calcium chloride, activated alumina, and most important in the present context, zeolite molecular sieve such as 3A or 4A having a very high capacity to tightly bind water while not absorbing larger molecules. A preferred desiccant material is zeolite molecular sieve 3A, whose approximate chemical formula is given by

⅔K₂O.⅓Na₂O.Al₂O₃.2SiO₂. 9/2H₂O.

The term “bind” includes any physical attachment or close association, which may be permanent or temporary. Generally, reversible binding includes aspects of charge interactions, hydrogen bonding, hydrophobic forces, van der Waals forces, etc., that facilitate physical attachment between the molecule of interest and the analyte being measured. The “binding” interaction may be brief as in the situation where binding causes a chemical reaction to occur. Reactions resulting from contact between the binding agent and the analyte are also within the definition of binding for the purposes of the present invention, provided they can be later reversed.

The terms “internal standard”, “isotope-labeled monitor fragment”, or “isotope-labeled monitor peptide” may be any altered version of the respective monitor fragment or monitor peptide that is 1) recognized as equivalent to the monitor fragment or monitor peptide by the appropriate binding agent and 2) differs from it in a manner that can be distinguished by a mass spectrometer, either through direct measurement of molecular mass or through mass measurement of fragments (e.g., through MS/MS analysis), or by another equivalent means.

“SIS” or “stable isotope standard” means a peptide or protein containing a peptide having a unique sequence derived from the protein product of a single gene and including a label of some kind (e.g., a stable isotope) that allows its use as an internal standard for quantitation (see U.S. patent application Ser. No. 10/676,005 “High Sensitivity Quantitation of Peptides by Mass Spectrometry”). Included peptides may have non-material modifications of this sequence, such as a single amino acid substitution (as may occur in natural genetic polymorphisms), substitutions outside the region of contact (including covalent conjugations of cysteine or other specific residues), or chemical modifications to the peptide (including glycosylation, phosphorylation, and other well-known post-translational modifications) that do not materially affect binding.

The terms “support”, “absorber”, “imbiber” or “imbibition zone” include any porous or absorbent material in membrane, sheet, tubular, bead, plug, particulate or other forms whose structure defines an included volume, and which can imbibe a liquid sample by capillary action or surface tension. Examples include filter papers (for example Whatman 903 and Ahlstrom 226 papers) and porous polymeric materials as described in U.S. Pat. No. 7,638,099 and US20130116597. A support can consist of one or more porous materials embedded or dispersed within other porous materials. A support can also be composed of particles embedded within another porous material (e.g., 3M Empore® membranes). A support can also be a material that maintains its shape during sample imbibition and drying, but which can be disassembled to yield a homogeneous suspension of sample plus suspended absorber particles or fibers (AQUACEL® Ag BURN Hydrofiber® Dressing can, for example, be used as such a soluble absorber (8)), or the absorber can be a dissolvable sponge material such as an absorbable collagen or gelatin sponge (e.g., SURGIFOAM® Absorbable Gelatin Sponges by Ethicon or GELFOAM Sterile Compressed Sponge made by Pfizer) which can be rendered completely soluble during the process of sample digestion (e.g., through the action of trypsin). The material of the support, and particularly the surface (internal and external) exposed to an imbibed liquid, is referred to as the matrix.

The term “imbibition” means the absorption of liquid into a porous support without pressure by means of capillary forces, and applies to supports that swell as well as those that do not.

By the term “imbibe” is meant to describe the process whereby a liquid is drawn into a porous material by forces of capillary action or surface tension. When a liquid sample is fully imbibed into a support, it is fully contained within the support, leaving minimal residual liquid outside the volume described by the outer surface of the support. The process of imbibition into a homogeneous support zone ensures that all elements of the liquid are exposed equally to enzymes or reagents evenly distributed within the support zone.

The term “paper” as used herein means any porous material in the form a sheet or strip. This includes conventional cellulosic papers, non-cellulosic membranes made of plastics (PVDF, polycarbonate, etc.), and membranes that are or are not homogeneous through their thickness (i.e., including plasma separation filter membranes). It also includes sheet materials formed as in paper manufacturing, or through other industrial processes such as those involving precipitation, spraying, extrusion, stretching, molding, drawing, rolling, etc. Such sheet materials may be of constant thickness, or may vary in thickness.

The term “plasma separator” refers to a membrane that is permeable to water and a range of solutes, but not to cellular components such as red cells, white cells and platelets present in biological samples such as blood. The term as used herein includes membranes that are permeable to macromolecules (such as proteins and free nucleic acids) as well as membranes with smaller pores that are permeable to ions, drugs and metabolites but not too large proteins.

The term “sugar” as used herein means any water-soluble (or sample soluble) solute that when dried in a paper or membrane can render the paper of membrane water or sample impermeable. The term thus includes many types of sugars, salts, polymers and other molecules that can be used to render a paper material temporarily water-impermeable in order to better define the internal volume of a paper-sampling device.

In one embodiment, the invention is embodied each separately or together as a one, two or three-part device including a sample vessel, a sample applicator, and a desiccant vessel.

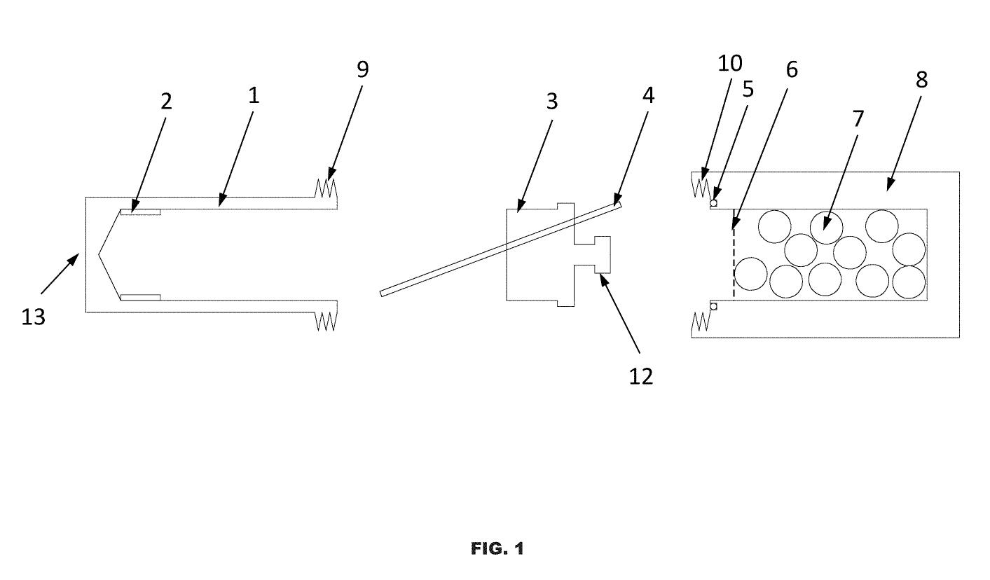

Sample vessel: As shown in cross-section in FIG. 1, the sample vessel 1 preferably contains a sample absorber, e.g., in the form of a zone (insert or region) capable of imbibing a sample, e.g., holding it in a configuration having an extensive surface area so as to speed its later drying. In one embodiment, the sample absorber comprises a strip of filter paper or similarly imbibing material 2 curled around the inside wall of the sample vessel. This configuration allows a pipette tip to reach the bottom of the tube, which is preferably conical or round-bottom in shape, to remove liquid from the tube when positioned in a vertical orientation (e.g., in a 96 position rack) in a sample processing workflow, without the pipette tip encountering the absorber and so running risk of blockage. In some alternative embodiments the sample is left lying at the bottom of the vertically positioned vessel, held in place by gravity rather than being imbibed into a zone, such that it is dried at the bottom or sides of the sample vessel. The sample vessel has an open end with a fastener, e.g., threads 9, that reversibly joins with the desiccant vessel so as to be able to make a tight seal, e.g., by screwing on a desiccant vessel (having matching threads 10). In order to function as a labeled sample container, the sample vessel preferably carries an identifier, e.g., a sample identifier, such identifier for example, a computer readable code, e.g., unique barcode on its surface, for example as a 2D barcode located on the vessel's bottom surface 13.

Sample applicator: The sample applicator consists of a volume-defining capillary tube 4 or equivalent device, into which sample is initially drawn and afterwards dispensed into the sample vessel. A guide cap 3 is optionally provided to hold the tube 4 and control its position and motions with respect to the sample tube 1. The guide cap may have a knob 12 to facilitate its positioning and ultimate removal by the user.

Desiccant vessel: the desiccant vessel 8 contains desiccant, e.g., as beads or particles of a desiccant material 7 (such a molecular sieve) held in the vessel by porous barrier, e.g., a porous frit 6. This desiccant material is capable of tightly binding water and in so doing extracting the water in the sample, thereby drying the sample. The desiccant vessel is configure so as to be able to make a tight seal with the sample container, for example using threads 10 to screw the two vessels together, compressing a sealing gasket or O-ring 5.

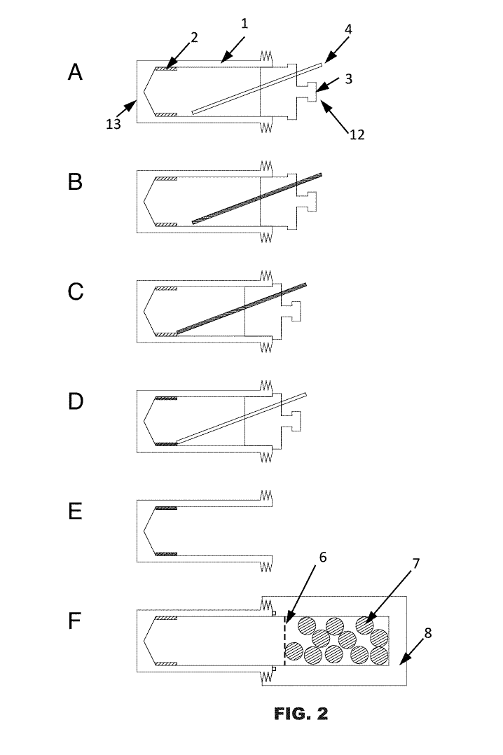

In a first preferred embodiment, the device of FIG. 1 is used to carry out the following steps, shown schematically in FIG. 2.

Sample vessel 1 is prepared for use, with the guide cap 3 containing sample applicator 4 placed in a partially inserted position (Panel A).

Sample (e.g., finger prick blood applied to the external end of the capillary) fills the sample applicator by capillary action (Panel B), taking up a predetermined volume of the sample. This process is most conveniently carried out with the capillary in a horizontal orientation.

In Panel C, the guide cap is further inserted into the sample tube, preferably to a fixed maximally inserted position established by a protruding rim of the guide cap, thereby bringing an open end of the sample applicator 4 into contact with an absorbent region of material in the imbibing zone 2.

The imbibing zone 2 imbibes the sample (Panel D), gradually emptying the sample applicator of its volume of sample.

The now-empty sample applicator, and the guide cap into which it is mounted, are removed from the sample tube (Panel E), facilitated by grasping a knob 12.

The desiccant vessel 8 is reversibly joined to (e.g., screwed onto) the sample vessel (Panel F), making a tight seal. Thereafter the desiccant 7 tightly binds water vapor in the now-closed container, reducing the humidity to low levels and in the process drying the blood in the imbibing zone.

In a preferred embodiment, the following features may be included:

The sample applicator is a precision volumetric capillary, such as those commercially available from Drummond Scientific, with defined internal volumes of 20, 44.7, 50 or 100 μL. The capillary is preferably coated internally with heparin so as to inhibit blood clotting, such as Drummond Scientific 44.7 μL precision blood capillaries. Accurate sample volume can be provided either by using a capillary of defined internal volume that is filled full from end to end before the sample is transferred to the sample imbibing zone, or the capillary may fill up to an air-porous hydrophobic plug that is subsequently pushed to deliver the sample into the sample imbibing zone (as in the Drummond Aqua-Cap product).

The sample applicator may be positioned in a variety of ways so as to be in one position when filled with sample and in another position later when sample is transferred to the sample vessel through contact with the imbibing zone. One approach, shown in FIGS. 1 and 2, positions a tubular sample applicator in a slanted configuration relative to the sample vessel so that its open end contacts an edge of the imbibing zone. Alternatively the applicator could be parallel with the walls of the sample vessel. The guide cap acts to facilitate the movement of the applicator between loading and emptying positions, either by means of a smooth displacement caused by the user, or in a snapping action of a bistable element causing the applicator to displace towards and remain in contact with the imbibing zone after a single push.

In one embodiment the sample imbibing zone is comprised of a rectangular strip of Whatman 903 paper (or other material with similar sample-absorptive properties likely to be approvable by FDA) curled around the inside wall of the sample vessel so as to form an interior belt contacting the tube wall near the end of the tube opposite a threaded opening. The size of the paper strip is selected so that the paper fits tightly into the tube when dry and does not come loose from the vessel wall when wet with sample, when subsequently dried, or during rehydration when the sample is processed for analysis. Alternative sample imbibing zones (absorbers) can be formed from porous polymeric supports, including molded polymer foams, such as those commercialized by Neoteryx in Mitra tips, or from dissolvable foam supports such as gelatin or collagen foams like those commercially available for surgical hemostasis (e.g., SURGIFOAM® Absorbable Gelatin Sponges by Ethicon and GELFOAM Sterile Compressed Sponge made by Pfizer).

In a particular embodiment, the sample vessel 1 is a plastic V-bottom or U-bottom tube with an inner diameter of 6.5 mm, and inner circumference of 20.4 mm. A paper strip, acting as sample absorber 2, is made of Whatman 903 paper 20.4 mm×5 mm, and is placed in the tube so that the long dimension curls around the inside circumferential wall of the tube, and the short 5 mm dimension extends along the length of the tube. Such a paper strip can imbibe approximately 45 μL of blood. The paper is inserted so as to take up a position at the bottom of the tube, its lower edge at the intersection of a conical bottom and the cylindrical vessel wall, or else touching the bottom of the vessel if it has a flat bottom. In one embodiment the paper is fixed in position in position in the tube, so as to avoid movement during collection, drying, storage, transport and final dissolution of the sample, by application of molten plastic or inert glue, or by being held in place by a partial or complete retaining ring of inert material positioned above the paper (i.e. closer to the vessel opening) and held in place by a friction fit, thermal bonding, glue or other equivalent means.

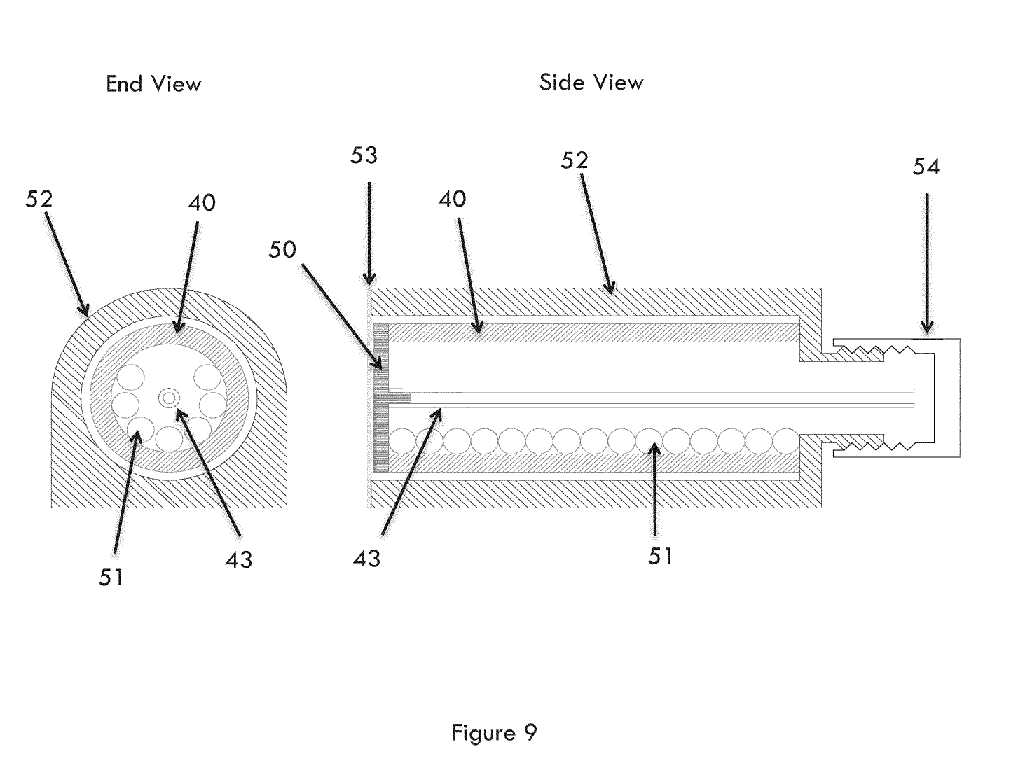

The sample vessel is preferably identified by a unique computer-readable identifier such as a barcode (1D or 2D) or an electronically readable chip. This identifier enables the sample vessel to be tracked during assembly and quality control of the device before use, through the process of sample collection (associating the sample and/or sample donor with the device), and subsequently through the process of sample preparation, including any transportation, storage or other manipulation steps. In a preferred embodiment, the identifier is a 2D barcode 13 placed on the bottom of the sample vessel button 50 (FIG. 9), so as to be readable from underneath or from above when the vessel in positioned in a rack. Examples of such vessels are commercially available, including Matrix 2D Barcoded Storage Tubes (https://www.matrixtechcorp.com/storage-systems/tubes.aspx?id=63) and Fluidx 96-Well Format Sample Storage Tubes with Screw Cap and 2D Barcode (http://www.fluidx.eu/96-well-format-sample-storage-tubes-with-2d-barcode.html), or alternatively a linear barcode printed on the outside of the sample vessel.

The sample vessel and any attached identifier (such as a sample vessel button) preferably have dimensions and shape enabling it to be positioned in a rack or plate capable of holding 96 such samples in an arrangement compliant with the SLAS dimensions and specification of a 96 well plate format, generally an array of 8×12 positions on 9 mm centers. Thus individual sample vessels can be collected, transported and stored individually, yet combined into sets of 96 for automation of a sample preparation process.

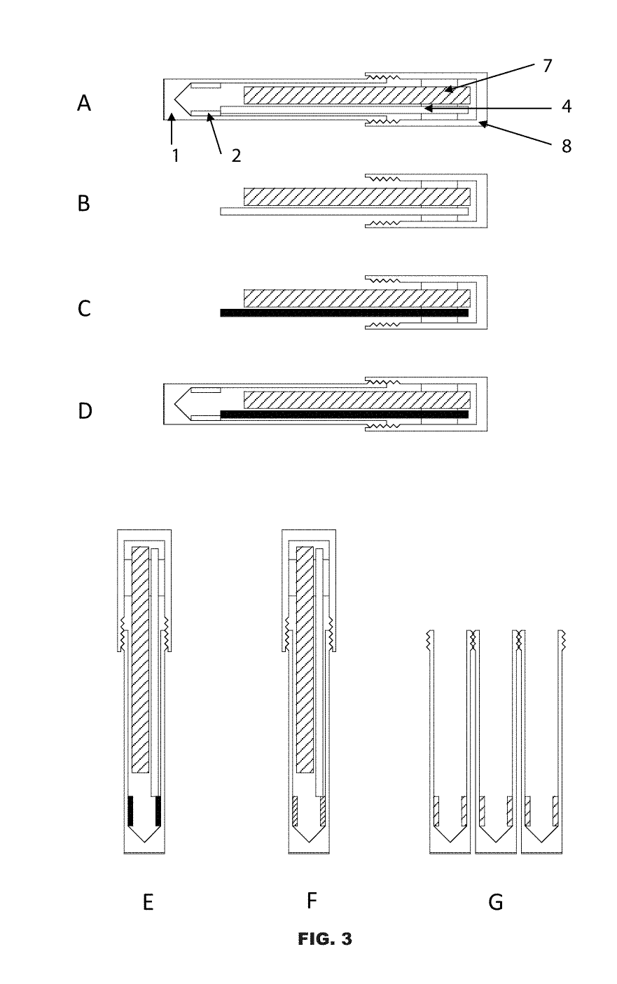

In a further preferred embodiment shown in FIG. 3, the sample applicator, comprising a capillary tube 4 of specified internal volume, is mounted in the desiccant vessel 8, together with a tablet of desiccant 7. The device is assembled and stored prior to use with sample and desiccant vessels tightly joined to exclude atmospheric moisture (Panel A). At the time of sample collection, the desiccant vessel is removed, exposing an open end of the capillary sample applicator (as shown in B). This open end is contacted with a liquid sample (such as blood), which is drawn into the capillary, filling it with sample (as in C). Filling the capillary can be simplified by positioning the device horizontally (as shown in C) so that gravity does not impede uptake of sample by capillary action, and also improving the visibility of sample inflow when collecting blood from a finger prick. The sample vessel is then re-assembled (in D) causing the open (loading) end of the capillary to contact the sample absorber in the sample vessel, and also sealing the two vessels together as a closed volume. The wicking action of the sample absorber causes sample to move from the capillary into the absorber (as in E) and exposing it to the atmosphere inside the closed vessels. This transfer can be aided by positioning the device vertically so that gravity helps move sample towards the absorber. Water evaporating from the exposed surface of the loaded sample absorber is then bound by the desiccant 7, gradually drying the sample in place on the absorber (as in F). The sample is now stabilized for storage and transport. Prior to analysis, one or more sample vessels are loaded into a 96-position rack (a section of which is shown in G). This embodiment has the advantage of combining sample volume control, sample transfer to absorber, sample drying and 96 well compatibility in a simple two-part device.

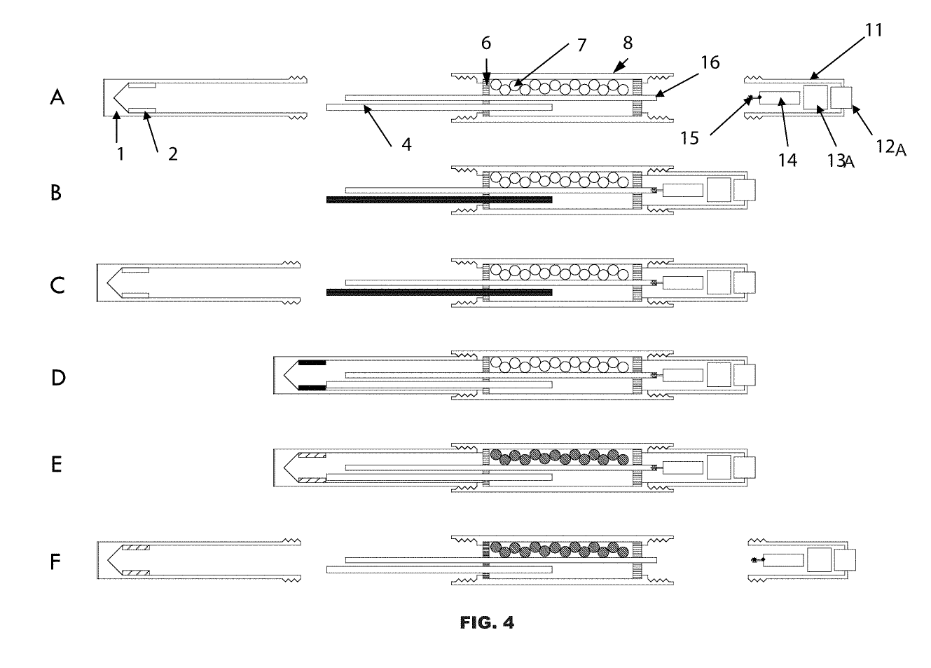

In a further preferred embodiment shown in FIG. 4, the sample applicator, comprising a capillary tube 4 of specified internal volume, is mounted in the desiccant vessel 8, together with desiccant 7 contained within porous walls 6 on either end of the desiccant vessel. In addition, an air circulation tube 16 is mounted in the desiccant vessel so as to direct flowing air towards the sample-imbibing zone. A third component 11 serves as an air circulator to move air down tube 16, over the sample imbibing zone, back through the frit 6, over the desiccant bed (where any water is captured on the desiccant), and back to the fan propeller and down the tube, in a continuous cycle. In this case the air circulator is comprised of a small electric motor 14 with a small propeller 15 mounted on its shaft, the motor being driven by current from a battery 13A and controlled by an on-off switch 12A accessible from outside the vessel. FIG. 4 shows the steps in use of the device: (A) shows the disassembled components of the device; (B) shows the desiccant vessel and air circulator assembled together and the sample collection capillary device filled with blood; (C) adds the sample vessel positioned for mating with the desiccant vessel; (D) shows the complete device assembled and the sample transferred by wicking from the capillary to the sample imbibing zone; (E) shows the result of the drying of the sample in the sample imbibing zone due to the action of the air circulator (the on-off switch having been turned on, connecting the battery and motor to rotate the propeller and force air down the air circulation tube), thereby relocating the water originally in the sample into the desiccant material 7; (F) shows the device disassembled to provide a dried sample in the sample vessel for subsequent analysis, a desiccant vessel containing the sample water, and the air circulator. The air circulator can be single use, or can be reused by replacing the battery or by recharging a rechargeable battery. A very small electric motor (such as a uxcell 52230 R/Min 12 mm×4 mm Cylindrical DC Coreless Motor 1.5-4.5V for RC Model), having a very small propeller attached to its shaft, can be driven by a small battery (including a hearing aid battery, or a rechargeable Li ion battery) to move air. The propeller is located within the open end of the air circulation tube 16 so that it propels air down the tube towards the sample-imbibing zone. Use of active air circulation offers at least two important advantages in comparison to passive sample drying methods: i) the sample dries more rapidly, and is therefore more quickly stabilized, and ii) a larger volume of sample can be managed than could otherwise be dried in a small device due to the distance between sample and desiccant. In particular, a device with active air circulation can be used to collect 50-100 μl of liquid sample such as blood, thereby increasing the amount of analyte available and thus the sensitivity of analytical measurements. After the sample is dry, the desiccant vessel can be weighed to determine the mass of water originally in the sample (after subtracting the vessel's tare weight previously measured), and can be reused by replacement of the sample capillary and removal of the absorbed water (e.g., by heating in a microwave oven). In a preferred embodiment each of the three vessels is identified by an individual barcode or other computer readable and/or human-readable label.

An electrically-powered version of the device as shown in FIG. 4 also provides the possibility of including powered electronics in the device (in this case in the air circulator component) capable of collecting and logging information about the history of the sample. Such an electronic component can carry out a variety of useful functions including i) storing a device serial number or other identification; ii) capturing the time of sample collection (through detection of the time the air circulator is turned on, or by sensing the addition of conductive liquid sample to the capillary or sample imbibing zone); iii) measuring the humidity in the vessel as a function of time to monitor sample drying; iv) measuring temperature as a function of time to detect abnormal conditions in storage or transport; v) recording GPS position as a function of time to track transport of the sample from the site of collection to the analytical laboratory; vi) recording accelerometer data so as to track manipulation and transportation of the device; vii) recording photographs of the user or the process of blood collection taken by a miniaturized camera in the device, or by an external camera (for example one in a cell phone) transmitting to the device; viii) communication of any of this information to external data collection and storage devices, either wirelessly (e.g., using Bluetooth, Wi-Fi, infrared, or other communication links) or by means of a direct electrical connection through a miniature plug mounted on the vessel. All these functions can be carried out by well-known, generally chip-based low power electronic components.

Alternatively the circulation of air inside the vessels can be powered by a mechanical means not requiring electrical power: e.g., a spring driven device. In one embodiment, a mechanical watch mainspring is used to power a propeller or fan through a gear train to drive air circulation inside the assembled vessel. The mainspring is wound manually prior to assembly of the device and triggered to start when the device is assembled with sample inside. The mainspring, gear train and fan are designed to provide air circulation for a period of time sufficient to achieve drying of the blood sample by transport of the sample's water to the desiccant, typically 1-12 hours dependent on the volume of blood collected.

Irrespective of the source of power used to circulate air in the device, the power can be communicated from a source outside the device (e.g., a battery, a spring, etc.) into the device by a variety of means including a magnetic coupling, inductive transfer of alternating current, etc. In one embodiment, a propeller or fan inside the device is rotated by means of a magnetic coupling to a motor (or spring drive) located outside the device. Such a coupling can make use of a small magnet (for example a permanent magnet) or a small piece of magnetically susceptible material (such as iron, cobalt, etc.) connected to the propeller or fan, and a magnet located outside the device that can be moved in a repeating motion (e.g., rotated) so as to cause the propeller or fan to move via magnetic force in such a way that it causes air to circulate between the sample and desiccant. Such an arrangement simplifies the design of components located inside the device, and facilitates use of reusable power packs outside the device. In some embodiments the power pack is included in the shipping package and thus continues drying the sample during shipment.

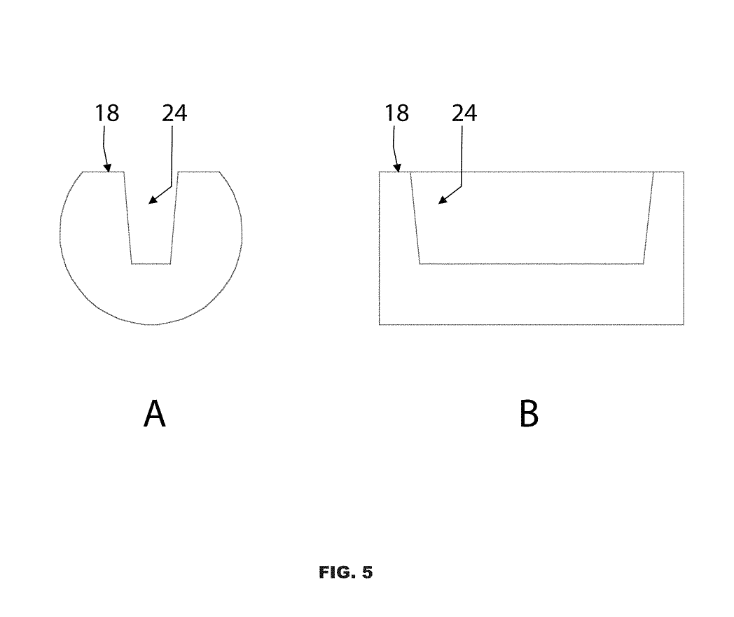

In a further preferred embodiment, as an alternative to circulation of air within the vessel to efficiently transport water from the sample to the desiccant, the desiccant is composed of a biologically inert water-insoluble substance (such as zeolite molecular sieve 3A) formed into a shape that can contain a wet sample in direct contact with desiccant where it dries in situ (FIG. 5, in which A shows a cross-section and B shows a longitudinal section through the shaped desiccant). Formation of tablets and other shapes of desiccant is well-known in the art, and frequently involves addition of a binder or polymeric plastic to the desiccant to make it retain a shape, for example after pressing into a mold. Once the sample is applied to the shaped desiccant, water diffuses from the sample into the contacting desiccant, whose mass and capacity is selected so as to be able to absorb and retain all, or nearly all, the water in the selected sample volume. The dried sample contents, consisting of essentially all the molecules larger than water and hence unable to enter the molecular sieve, are retained in dried form on the surface of the shaped desiccant. This dried sample can be rehydrated prior to analysis by exposure to sufficient water to both fill any remaining unfilled desiccant capacity and dissolve the dried sample, thus extracting the sample contents with high efficiency.

In one preferred version of this embodiment, the desiccant is formed with a cavity capable of taking up and retaining a specified volume of sample, e.g., by capillary forces, and so is able to measure a liquid sample in the way that a convectional glass capillary measures sample. Once the cavity is filled, contact with additional sample is ceased and desiccation of the sample proceeds slowly to sample dryness (preferably less than 10% relative humidity, or more preferably less than 5% humidity). Hence in this version the shaped desiccant determines the volume of sample (i.e., the cavity's volume) and also dries it into a stable form. Sample is later recovered by rehydration of the desiccant and release of the sample constituents. The desiccant is preferably chosen to be unable to absorb the analytes to be measured (so they are retained on the surface and do not become trapped in the desiccant material, as would be case with type 3A molecular sieve for example). Although when a water-insoluble desiccant carrying a dried sample is exposed to sufficient water to both fill any remaining unfilled desiccant capacity and dissolve the dried sample, even analytes that penetrate the desiccant can be recovered in a sufficiently long incubation.

Direct contact of a biological sample with a desiccant, before, during and after sample drying, is substantially different from uses known in the art, as is the use here of desiccant objects formed with volume-defining holes. The use of desiccants, particularly molecular sieves, for sample collection as described herein therefore involves unique topological shapes for desiccant objects, as well as unique individual identification of these objects or their containers.

An embodiment of such a configuration is shown in FIG. 5, consisting of a “boat” shaped mass of molecular sieve material 18 with a cavity for containing a volume of sample, e.g., a slot-shaped cavity, 24. Cavity 24 is loaded with liquid sample, which is afterwards desiccated by the desiccant 18, leaving the dried (non-aqueous) sample constituents dried on the walls of the slot. The boat may preferably be sized so as to fit inside a sample extraction vessel (which can be a well of a 96-well plate for example). A dried sample placed in such a well can be extracted from the boat by adding sufficient water to the vessel and shaking the vessel and boat. The boat material may absorb water to fill any remaining desiccant capacity, while the remaining external liquid dissolves the dried sample in preparation for processing of the recovered sample. The desiccant boat may be removed from the vessel in which sample is recovered.

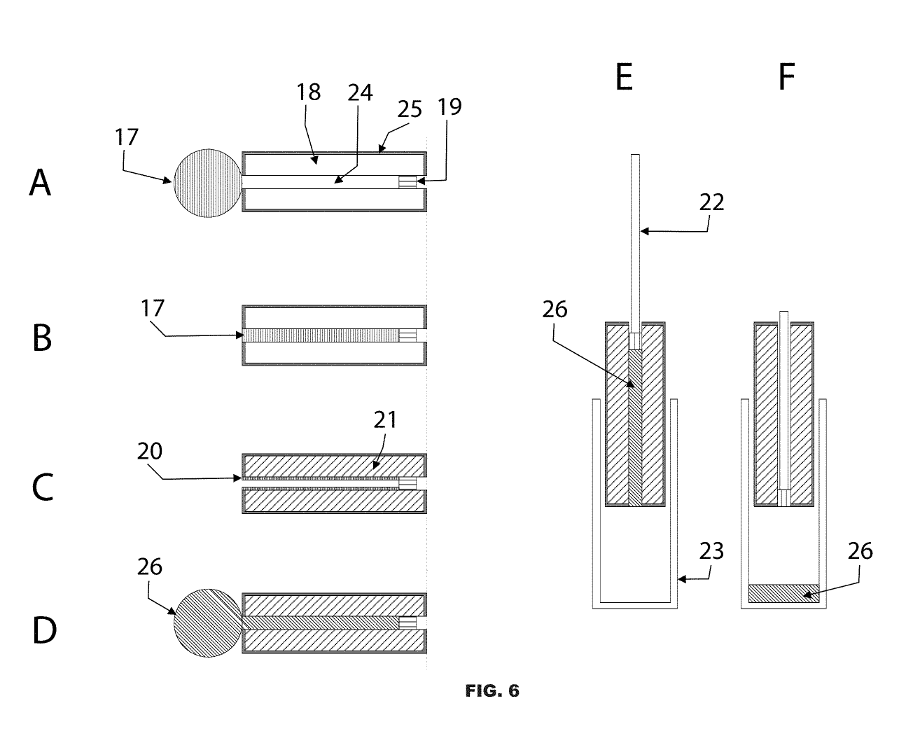

In a further preferred embodiment, shown in longitudinal cross-section in FIG. 6, the cavity for containing a volume of sample is a tube 24, e.g., a capillary tube, formed by a hole in the molecular sieve desiccant 18 (here shown as a cylinder of desiccant). This hole may be filled with aqueous sample 17 by capillary action (Panel A, leading to a filled hole in Panel B). The hole may be a straight or curved, of constant or variable diameter, of circular or non-circular cross-section; the hole as depicted in FIG. 6 is a straight hole of uniform diameter that is concentric with the outer profile of the desiccant mass, making it particularly easy to manufacture by extrusion. Otherwise the hole can be formed in a compact mass of desiccant by drilling, by laser ablation, water-jet cutting, or any of a variety of methods known in the art for machining by material removal. The device can be identified on its exterior surface by a barcode or other machine or human readable markings so as to clearly identify the sample collected within it. The desiccant tube may be coated with a stabilizing and/or water resistant coating, e.g., an abrasion-resistant, hydrophobic and/or impermeable coating 25 (such as a paint, lacquer or plastic coating, or a heat-shrink plastic tube) over its external surface (other than the openings of hole) so as to improve the stability of the device to handling and external water uptake (the ends of the hole and the hole's interior surface remaining uncoated so as to interact directly with introduced sample liquid). A unique machine-readable code (e.g., a barcode) is preferably printed on, or adhered to, the tube (e.g., on the outer tubular surface, and/or on one or both flattened ends of the tube) to allow identification of the device and the associated sample. A plug, e.g., a hydrophobic plug 19 that is non-porous to aqueous liquids but permeable to air (e.g., due to hydrophobic character: such plugs are well-known in the art from use for example in Drummond Aqua-Cap single use, disposable glass capillary pipets with hydrophobic plug) may optionally be positioned in the hole to provide a barrier establishing the point up to which the sample may fill the hole (B), or the plug may be omitted and the hole filled with sample from end to end. In panel A, the desiccant sampling device is brought into contact with a droplet of blood (or other liquid sample) 17, whereupon capillary action causes sample to entire hole 24, filling it up to the plug (panel B). After the hole is filled, and contact with the sample droplet is ended, water from the sample is absorbed by the desiccant, yielding water-loaded desiccant 21, and causing the dissolved contents of the sample to dry in the hole to yield a solid sample 20 largely adhered to the walls of the hole (panel C). The sample is now stabilized for transport and storage. Sample can be later recovered by immersing the device in liquid (preferably in the case in which a hydrophobic plug barrier is not used), in which case recovery can be accelerated by shaking to improve dissolution of the sample. Alternatively a sample solubilizing liquid 26 can be introduced into the hole (Panel D), dissolving the dried sample constituents, and this redissolved sample ejected from the desiccant tube by insertion of a plunger 22 (E) that displaces the hydrophobic plug along the hole, emptying the hole of the redissolved sample contents 26 into a receiving vessel 23 for further processing. A further alternative recovery method is to use the plunger to displace the plug so as to eject the dried sample material from the hole into a receiving vessel.

The desiccant tube can be conveniently formed as a cylinder with a concentric central hole to take up sample, or it can have a variety of other shapes chosen for ease of manufacturing. The device can be manufactured using a variety of well-known methods, such as compression in a die, as used in the art for producing tablets of pharmaceuticals and other powdered materials, or extrusion of a paste including zeolite molecular sieve desiccants or combinations of desiccants and binders through a die, after which the extrusion is cut into sections and processed to dry and solidify the molecular sieve material. These production methods offer the possibility of large volume production at low cost, enabling the device to be used to collect frequent (i.e., numerous) samples for analysis.

The desiccant tube can be provided in a sealable container (e.g., a screwcap vial, a snap top vial, a Ziploc bag, etc.) so as to avoid introduction of atmospheric moisture. After sample is collected, the desiccant tube device can be replaced in such a vessel for shipment or storage.

As an example of the principle involved in this embodiment a bead of molecular sieve 3A (Delta Absorbents) having a diameter of approximately 4.8 mm was pierced with a small hole (approximately 1.6 mm diameter) using a Dremel drill tool. The hole was filled with a human blood sample (approximately 10 μl) by capillary action. Within two hours, the water was extracted from the blood by the surrounding molecular sieve, resulting in a dried film of blood lining the hole and leaving the central bore of the hole empty. Later the bead was exposed to water to redissolve the blood constituents, with the result that no detectable color (e.g., the red of hemoglobin heme) or film remained on the molecular sieve surface. When the bead was later cracked open so as to reveal a cross-section of the molecular sieve and the hole, no penetration of blood material was observed and no color remained on the surface or in the molecular sieve material. The molecular sieve was thus shown to be an effective desiccant when in direct contact with blood, and to be effectively inert so as to allow efficient recovery of the dried sample without leaving any residue on the sieve.

This embodiment has the advantages that i) sample volume is accurately determined by the volume of hole 24 (up to the plug, whose position determines the available volume); ii) the sample is rapidly dried to very low water content by immediate proximity to a powerful biologically-inert desiccant; iii) the sample can be recovered and reconstituted in a small volume, and iv) the device can be easily handled by a user, who pricks a finger to create a drop of blood and then, holding the device, touches an open end of the tube to the droplet, filling the tube (after which the device is stable and self-actuating, and can be placed in a transport container).

The total amount of sample actually loaded can be determined by weighing the device after sample loading but before recovery of the sample and subtracting the weight of the device measured prior to sample introduction (e.g., during manufacturing). This sample amount can be used both as a quality control metric (to ensure availability of adequate sample for analytical processing) and for normalization of analytical results to a correct concentration basis.

Additionally, if the dried sample is ejected prior to redissolution, the device of FIG. 6 can be weighed after ejection of the dried sample to determine the mass of extracted water, and the ejected dried sample can likewise be weighed in a tared receiving vessel to determine the mass of dry sample.

In a further embodiment, the sample vessel comprises a capillary whose wall is made of a “plasma separator” membrane, i.e., a water permeable membrane that is not permeable to blood cells and platelets. In this case, once a blood sample is loaded into the sample vessel, water escapes through the membrane and is absorbed by the desiccant, and this moving water carries with it the sample proteins, salts, drugs, lipids, etc., while the cells remain inside the lumen of the capillary. Once the sample is fully dried, all of the cellular contents remain inside the sample vessel lumen while most of the plasma components (proteins etc.) are dried on the outside of the sample vessel. This separation makes it possible to recover the plasma constituents separated from the blood cells—i.e., achieving a sample equivalent to a conventional serum or plasma sample instead of whole blood. Plasma recovery can be achieved by applying and removing solvents (e.g., aqueous buffers) to the outside of the sample vessel, by applying solvents to the inside of the sample vessel (e.g., flowing through the lumen) to recover the blood cell contents, or by a variety of other strategies,

In a further embodiment of a sample collection device in which sample comes into direct contact with a desiccant (e.g., molecular sieve) powdered molecular sieve can be packed into a tube (made of plastic, metal, glass, or other water-insoluble substance) as a porous bed, such that a liquid sample drawn into the tube by capillary action (or by suction) would subsequently be dried in place by uptake of sample water in the molecular sieve particles, and could later be rehydrated and recovered by filing the tube with more liquid (enough to fill both the particles and the interstices) followed by expulsion of the interstitial liquid containing the redissolved sample.

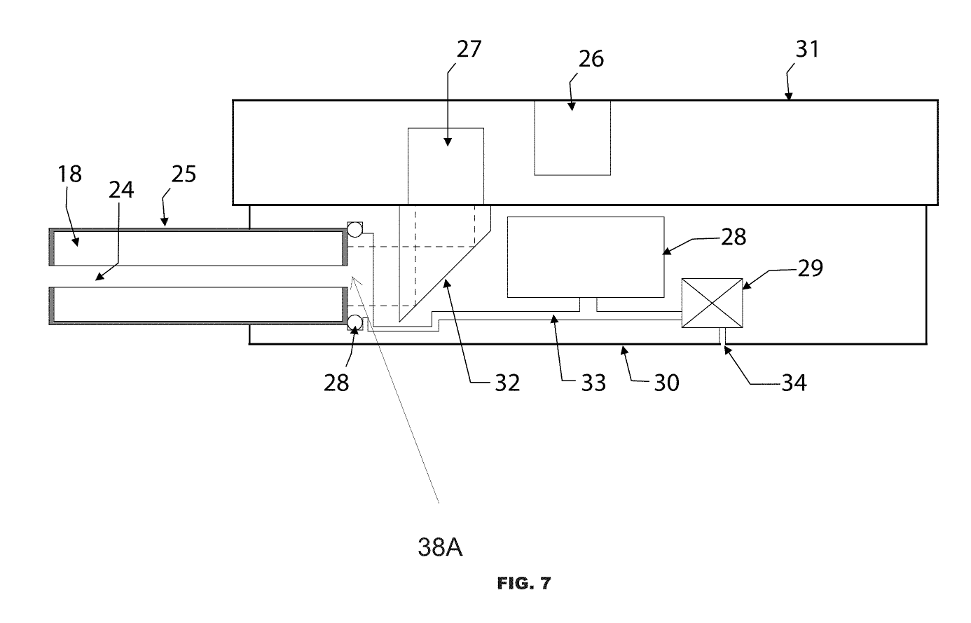

A further embodiment using the desiccant tube sample collection device of FIG. 6 is shown in FIG. 7. A sample collection assistance device 30 is attached to the back of a mobile device, e.g., a smartphone 31 (e.g., an iPhone), in which a tubular sample collection device made of desiccant 18 covered with coating 25 and having sample hole 24 is mounted in a port 38A in the sample collection assistance device and sealed with a port seal, e.g., with an O-ring 28. The cellphone's “backside” camera 27 images the end of the collection device reflected in an angled mirror 32, and in so doing images a barcode identifying the device. The cellphone's “frontside” camera 26A images the user in the act of collecting the sample, providing positive user identification. An internal channel 33 connects the collection device with a vacuum pump 28 and a release valve 29, which, when open, connects to the outside air via an air port opening 34. To collect a sample, the user uses a lancet to make small puncture in the skin, and then places the open end of the sample tube 24 against the punctured site. Vacuum pump 28 is then activated, with release valve 29 closed, and the applied vacuum causes blood to be withdrawn from the skin puncture more effectively than in the absence of vacuum. When hole 24 is filled, camera 27 detects the arrival of blood in its image of the end of the tube, and causes the release valve to open and the vacuum pump to switch off, resulting in a completely filled, but not over-filled, tube 24. At this point the collection device may be removed from the collection assistance device 30 and the sample allowed to dry.

Many advantages flow from the direct association of a smart digital device with the act of collecting a sample (e.g., a capillary blood sample). The association of the user (in general the owner or authorized use of the phone) is established using security features native to current phones (fingerprint ID, etc.). The time, date, and GPS coordinates at the moment of collection are easily recorded, as are voice comments of the user providing useful health-related annotation. Contextual data such as heart rate and levels of exercise can be collected directly by the user's smartphone, and additional data such as weight, blood pressure, blood glucose, etc. can be measured externally and collected by the smartphone as context in the interpretation and use of biomarker data generated form blood samples collected according to the invention. A variety of other sensors can be incorporated in future.

A cellphone, particularly a smartphone, can also be used to provide the user with pictures, video and audio help with the sample collection process itself. Examples include the action of preparing and lancing a fingertip to provide blood, the operation of the collection device and the subsequent storage and shipping to an analytical laboratory. This help can be pre-generated or can include live contact with a human assistant.

Analytical data resulting from analysis of samples using the device, including longitudinal data collected as a series of samples over time, can be delivered to a subject, healthcare providers or others via mobile devices including cellphones, iPads, and the like. In a preferred case, prior results from a subject's serial samples and/or other contextual data are interpreted by computer algorithms (or by human consultants) and the conclusions of this interpretation are used to determine the timing of collection of subsequent samples. For example, if a potentially significant change in observed in the level of a biomarker in the most recent sample, or if a subject's contextual data shows a major change in mobility or resting heart rate, the subject could be informed as a result of the data interpretation that it is advisable to alter the frequency or timing of future sample collection, e.g., to collect another sample soon in order to confirm the existence and/or magnitude of the suspected change, or to perform additional biomarker tests. Establishment of a closed loop of communication between subject and analytical result provider offers a major improvement in the user experience and in the performance of tests carried out on the samples.

In various embodiments the sample vessel can itself act as an imbibing zone, for example when it is made of a porous material (such as paper). In one version of this device, the applicator/imbibing zone is a paper tube of small diameter, for example between 0.5 and 2 mm, that can take up a specified volume of liquid sample by capillary action, filling the bore of the tube, and (if the paper of the tube is permeable to the sample) the tubing bore plus the volume of the paper itself. After filling the tube, the sample water can be removed through the walls of the tube: i.e., by evaporation through the tube walls due to the ability of water to flow through the paper tube walls. In the case of simple paper walls (made for example of filter paper) water evaporates from the exterior wall surface and gradually pulls the water from the sample in the tube lumen, gradually emptying the lumen and resulting in a dried sample coating the internal wall of the tube and permeating the wall itself. In the case of a wall made of a material that is not permeable to bulk water, but is permeable to water vapor (for example the membrane known as Gore-Tex, which has “billions of micro pores per square inch, each about 1/20,000 the size of a water droplet but 700 times the size of water vapor”: https://gearjunkie.com/waterproof-breathable-fabric; or a laminated membrane combining a Gore-Tex-like membrane with a structurally more robust layer of paper, fabric or similar sheet-like substance), the tube can imbibe a volume of sample in its lumen but the bulk sample may not permeate the walls of the tube to the outside surface. The tube-like geometry of the device provides a large external area (the exterior wall surface) from which sample water can be extracted. The volume of sample collected can be greater than that afforded by a typical ¼″ punch from a dried blood spot card: 50 ul sample can be loaded into a paper tube with inside diameter 1.38 mm and 3.3 cm long (dimensions which allow it to fit into commonly available microvials or the wells of a deepwell 96-well plate), or a filter-paper tube of 1.38 mm inside diameter and 5 mm long can take up 115-135 uL of sample, whereas a typical ¼″ punch of Whatman 903 paper holds approximately 14 ul of blood. In case where more even more sample is required, multiple tubes can be used for sample collection, optionally packaged into tubing bundles for easy loading and subsequent manipulation.

In one version of the device of this embodiment, the wall material is treated with a water-soluble material such as sugar that makes the wall temporarily impermeable to sample, while later, once this water-soluble material has dissolved in the sample, the walls are rendered permeable to sample, and most importantly, to the water contained in the sample, which can then evaporate form the exterior face of the tube wall. In one embodiment, the water-soluble material is sucrose (or trehalose, or any of a range of hydrophilic solutes that do not interfere with subsequent sample analysis), which is applied to the tube as a solution during device manufacturing, and subsequently dried in place. The result is a hydrophilic tube that is i) stiffened (i.e., has greater mechanical robustness) than the untreated tube, ii) rendered temporarily impermeable to sample liquid, thus restricting the volume of sample to the lumen of the tube (and excluding the volume of the wall itself); and iii) capable of becoming water-permeable once the sugar dissolves in the sample (which can take from a few seconds to several minutes depending on the amount of sugar deposited in the wall). In one version of the embodiment, a paper tube is permeated with a solution of 50% sucrose during manufacturing and this sugar is dried in the paper while the tube is positioned on a mandrel of defined diameter. The sugar dries to solid form in the paper and the interior surface of the paper is coated with a sugar layer whose internal diameter precisely mirrors the outside diameter of the mandrel (an approach that imitates the process of forming glass syringe barrels around a mandrel to make high-precision syringes). In this way, a smooth internal surface of defined internal diameter is provided in the tube, thus allowing accurate control of the imbibed sample volume (in this case a function of the length of the tube used).

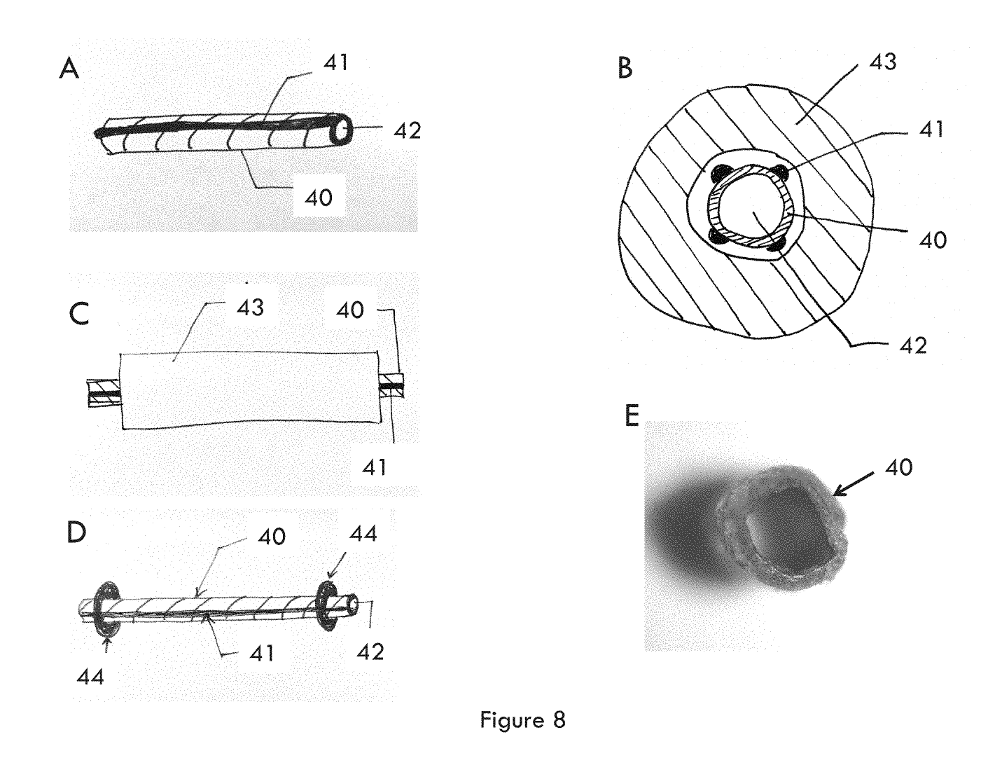

The permeable walls of the tube 40 can be formed of paper or a variety of other materials such as plastics or metal having holes that allow passage of liquid or water vapor. Ideally at least the internal surface of the tube is hydrophilic so as to draw sample liquid into the lumen (42) of the tube (40) by capillary action. In the case of paper walls, tubes can be efficiently manufactured using the spiral winding process use to manufacture common paper drinking straws (http://www.lookatwhatimade.net/crafts/paper/make-your-own-paper-drinking-straws/, or https://www.youtube.com/watch?v=qaiR3N_EZuk). Using this method paper tubes can be prepared using filter paper such as that used in existing dried blood spot cards (e.g., Whatman 903 paper) or other filter papers used in laboratories or even paper used in common coffee filters. FIG. 8E shows a cross-section of a section of a paper tube of 1.38 mm inside diameter formed from filter paper (coffee filter), loaded with blood, and subsequently dried in 2 hours by exposure to air and mild heating: the dried blood is located in and on the surfaces of the paper, while the lumen is empty. Spiral windings can be adhered to one another using a narrow bead of wax, thermo-setting glue, epoxy resin (or other adhesive that is compatible with later sample analysis) applied so as to join adjacent helical windings together into a robust tube, or in a manner that lays down longitudinal stripes (41 in FIG. 8) that keep the helical windings together forming a tube. A helically-wound paper tube can be further strengthened by providing an external thread wound in the opposite helical hand, so as to prevent unwinding of the paper. An advantage of such a helical winding method of manufacture is the very low cost of individual pieces cut from a continuously produced tube. Alternatively the tube can be formed by molding or extrusion of a porous material (such as the material used in manufacture of Mitra devices manufactured by Neoteryx), or they can be made of a membranous material such as those for dialysis tubing (typically cellulose derivatives), plasma separation membranes, wicking membranes of various types used in lateral-flow diagnostic devices, sintered metal, glass or plastic, or any of a variety of other water permeable substances. Tubes of circular cross-section are particularly easy to manufacture, but tubes of square, triangular, star-shaped, or various other cross-sectional shapes can also be made and can serve the desired purpose. Simple sample tubes can be made by stacking layers of planar water-permeable material in which slits in one or more internal layers form channels allowing free flow or liquid through the vessel.

While a tube geometry is the simplest form for such a sample vessel, any geometry with internal cavities with dimensions small enough to promote filing with sample by capillary action could be used. Non-tubular sample vessels include three-dimensional sponges and open cell foams in a variety of shapes. As for tubular sample vessels, preferred non-tubular shapes have sufficiently large internal channels to promote rapid filling by transport of sample liquid throughout the vessel, and a large external surface area in relation to the sample volume so as to facilitate rapid drying of sample by evaporation from the vessel exterior surface.

The physical robustness and handleability of a thin-walled tube of paper can be improved by addition of one or more external reinforcements or “handles”, an example of which is the application around the exterior of “bumpers” 42 in FIG. 8D consisting in this case of inert silicone rubber or Teflon O-rings slid onto the tube from the ends.

Alternatively one or more beads of glue or inert material 41 applied to the outer wall surface to strengthen the tube can also serve as bumpers (as shown in FIG. 8B). Such bumpers can serve to hold the tube away from contact with the walls of a container or other adjacent materials such as desiccant, preventing loss of sample onto these external components or contamination of sample by contact with the external components.

The devices of this embodiment can be individually identified using a barcode applied lengthwise along the tube, or circumferentially around the tube during manufacturing. Alternatively a small inert device such as the sample vessel button 53 in FIG. 9 may be used to hold the sample vessel in position. In this case the button is shaped similarly to a thumbtack whose spine is inserted at one end into the lumen of a capillary tube sample vessel 40, and whose flat portion provides a planar surface for a computer-readable sample-identifying code as well as a handle for use in subsequent manipulation of the sample vessel.

In one version of this embodiment shown in FIG. 8B and D, the sample-containing paper tube 40 is placed inside an outer tube 43 of desiccant that takes up sample water evaporating from the outer surface of the tube wall. Alternatively the desiccant can be positioned in a nearby container. By placement in close proximity, the rate of drying, and hence stabilization, of the sample by transport of water to the desiccant can be maximized.

The sample's dry weight can be established by measuring the weight of the tube before and after loading/drying of sample, and the weight of water contained in the original sample can be established by measuring the weight of the surrounding desiccant before and after loading/drying of sample, as described elsewhere in this disclosure.

Samples dried in the tubular sample vessels of this embodiment can be recovered by immersing the sample vessels in a vessel of liquid while sample solutes dissolve and are extracted into the bulk liquid by diffusion, stirring, or other forms of mixing including ultrasound. Alternatively, sample can be recovered by filing the sample vessels with solvent (typically water, optionally including buffers, detergents, denaturants and/or disulfide reductants), waiting for sample solutes to dissolve, and then removing the liquid from the tube lumen by centrifugation into a receiving vessel, or through a rapid linear acceleration or deceleration to displace the lumen contents into a receiving vessel. In this method, a paper capillary lumen can be loaded and dissolved sample solutes recovered multiple times to increase total sample recovery.

Particular advantages of this porous tube approach include manufacturability from inexpensive simple materials (in the case of e.g., paper) using existing mechanical manufacturing processes (e.g., those used in making paper drinking straws and applying barcodes in production processes). A porous tube with a capacity of 150 uL of a sample such as blood can be used to collect 150 uL or any lesser amount, and, using the weight determination methods described herein, the actual sample amount, including water weight and dry solids weights, precisely determined later, e.g., in the analytical laboratory. Hence a single device can serve for collection of samples in widely varying amounts without sacrificing the possibility to calculate the concentrations of various analytes (which are correlated to sample volume).

The sample vessel is provided with a companion desiccant vessel comprising a desiccant mass capable of taking up an amount of water similar to or greater than the amount of water in the sample. The desiccant vessel and included desiccant are shaped so as to hold the desiccant in close proximity to the sample vessel walls and thus promote rapid and efficient transfer of sample water to the desiccant by evaporation once sample is loaded into the sample vessel. The desiccant vessel may be formed of desiccant or else desiccant may be attached to or contained in a suitably shaped container. Thus the desiccant can be provided as a cylindrical tube within which a capillary-shaped sample vessel can be positioned so as to approach but not touch the desiccant vessel walls (FIG. 8B), or the desiccant can be provided in the form of commercial molecular sieve beads (such as molecular sieve 4A Blue Indicating Molecular Sieve Desiccant from Delta Absorbents: 43 in FIG. 9) bound (e.g., by an adhesive such as epoxy resin) to the inner wall of a plastic tube carrier 51 (FIG. 9), or to a separate liner within such a tube. In the device as shown in FIG. 9, desiccant vessel 51 is made of clear plastic or glass, and carries molecular sieve desiccant beads adhered to its inner surface except for a longitudinal strip devoid of beads which permits visual inspection of the sample vessel 40 positioned in the device. This “window” in the device allows a user to observe the filling of the sample vessel with sample, such as blood.

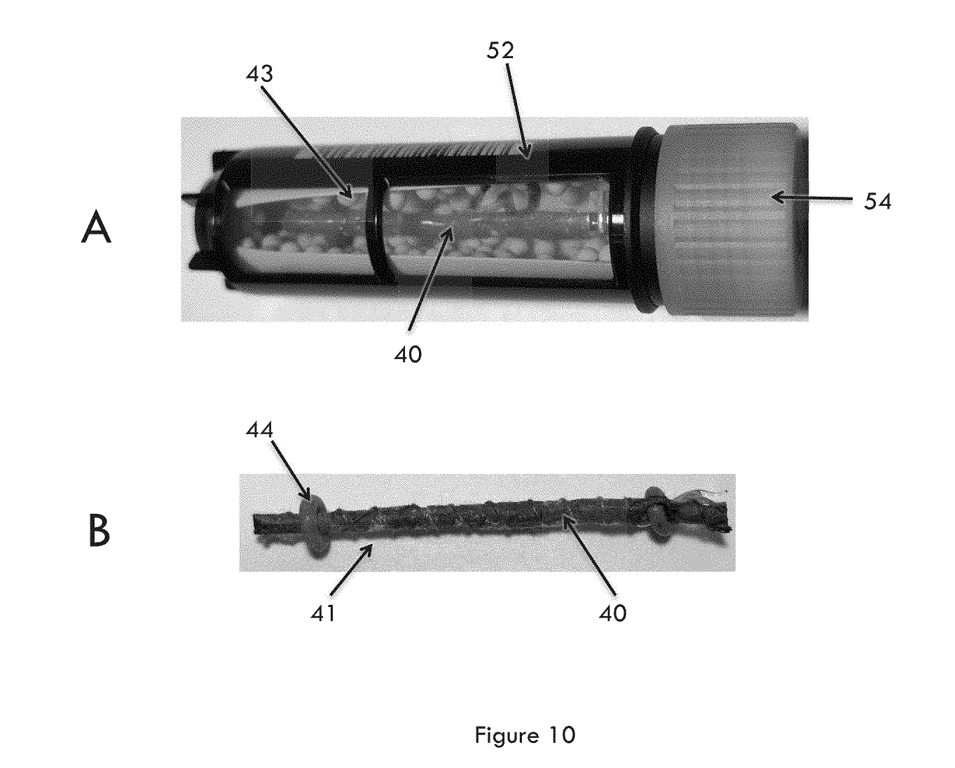

In the example shown in FIGS. 9 and 10, the sample vessel is mounted within and coaxial with a desiccant vessel comprising a layer of molecular sieve beads stuck to a support, which in turn is mounted within a vial (or package). The external vial has a screw cap on one end allowing access to the loading end of the sample vessel. In the device of FIG. 9, the opposite end of the vial is closed by a removable water-impermeable film which remains in place during sample loading, drying and transport, but can be removed in advance of sample analysis to allow extraction and separation of the sample and desiccant vessels.

In a further embodiment, a sample vessel (such as a vial or capillary tube) can be pre-loaded with desiccant (such as a powder or beads of molecular sieve material) in sufficient quantity to absorb all the sample water. Once sample is loaded into such a vessel, the water will be extracted by direct exposure to the desiccant and rendered stable for transport and storage. In this embodiment, the desiccant fulfills the roles of both desiccant and sample imbibition zone.

In yet another embodiment, the sample collection devices (e.g., those of FIG. 6 or FIG. 9) can be incorporated into a mechanical shell package to further enhance user convenience. Instead of a screw-cap vial (52,54) as shown in FIG. 9, a preferred embodiment, the cylindrical collection components of FIG. 9 can be mounted inside a plastic shell in a retracted (closed) position, and the open end of the sample vessel 40 (through which sample is collected) is briefly exposed by action of a push-button to allow sample to be introduced, after which the device is retracted into the shell where it is isolated from the atmospheric humidity during transport and storage. One format for such a mechanical shell package is that used in the commercial Sharpie ACCENT Retractable Highlighter to store the highlighter marking tip in a closed internal compartment (to prevent drying) while allowing the highlighter tip to be exposed temporarily for use by action of a push-button (like a common retractable ballpoint pen). The shell mechanism can be constructed so as to allow the user to expose the sample collection point only once, thereby preventing later tampering with the contents prior to opening at an authorized analysis facility.

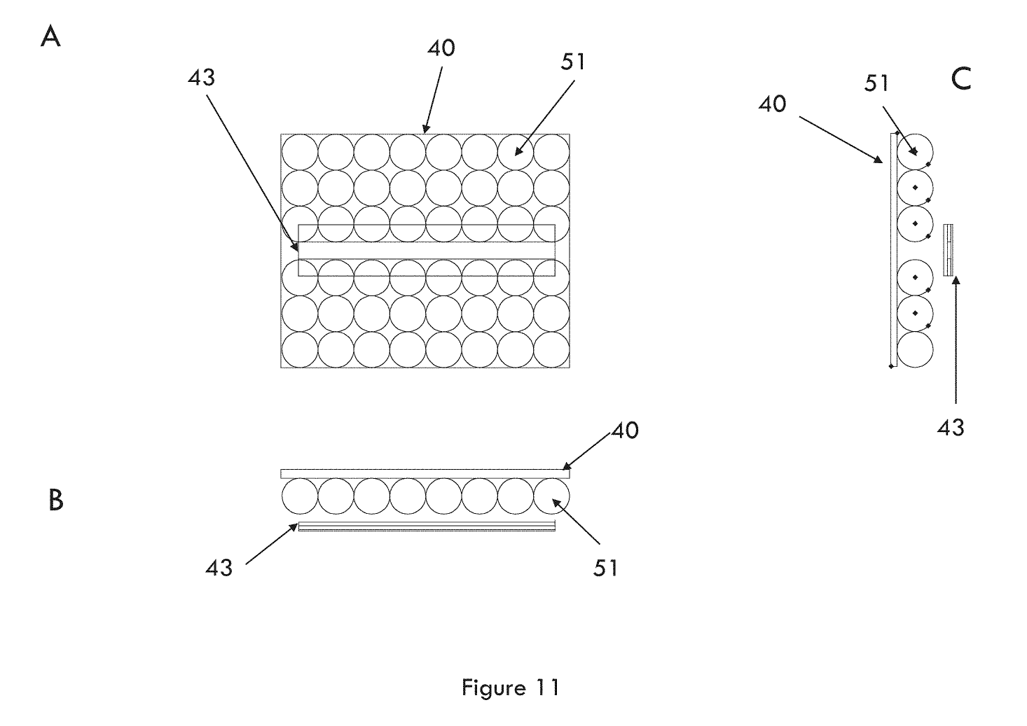

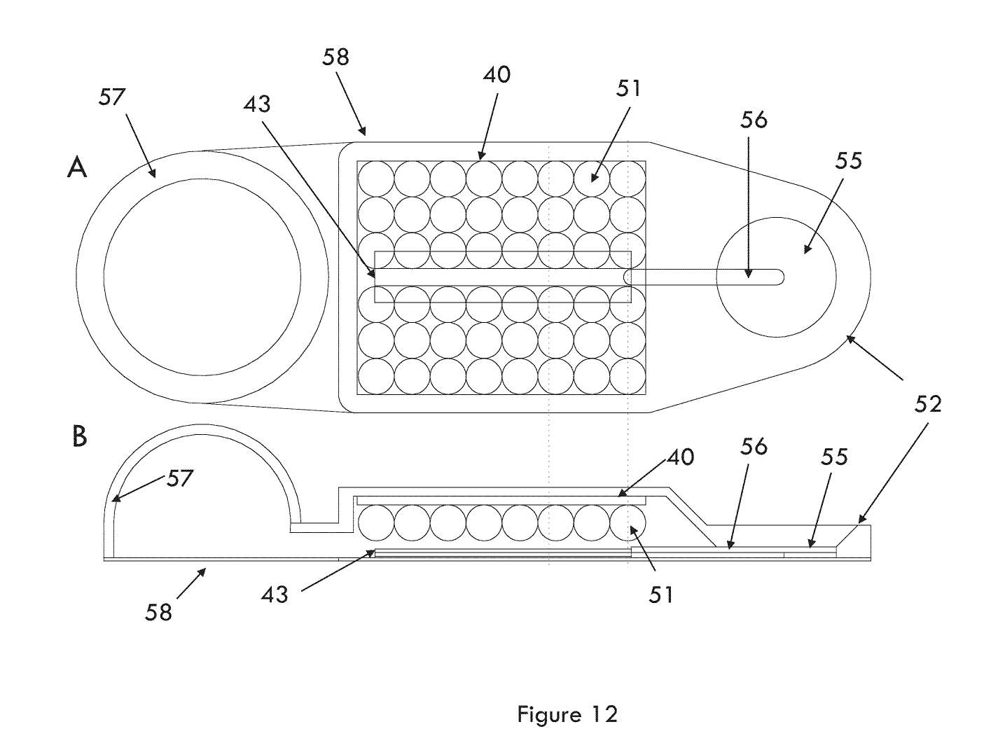

In a further related embodiment, shown in FIGS. 11 and 12, a sample absorber (sample vessel) 43 comprising a porous material such as paper is prepared in a planar format, and placed close to, but not touching, a planar mass of desiccant, with an air gap in between. In the embodiment shown, the desiccant is composed of molecular sieve beads 51 adhered to a carrier 40 in the form of a planar sheet. FIG. 11A shows a view of the stacked desiccant and sample vessel components from above; FIG. 11B shows the same components from the side, and FIG. 11C shows these components in an end view. Alternatively a formed tablet or plate of desiccant such as molecular sieve could be used. The sample vessel can be made of a sheet of filter paper, and can comprise multiple layers, optionally including one or more channels in or between layers to assist in free flow of sample entering the vessel during loading, reducing resistance and increasing speed of sample inflow. The sample vessel is optionally attached to a rigid carrier sheet to assist in handling the vessel, and on which a barcode may be printed to uniquely identify the vessel. In a preferred embodiment, the sample vessel is sized so as to fit within the dimensions of a liquid vessel: e.g., a ˜6 mm wide, 30 mm long and 1-2 mm thick sample vessel, capable of fitting in a well of a standard 96 well plate, into which the dried sample can be placed to effect the sample preparation procedures required for subsequent analysis of sample contents. Alternatively the sample vessel can be formed (e.g., by molding or extrusion) from a porous material such as a plastic or a gel. In FIGS. 10 and 11, a long, narrow sample vessel comprising 2 layers of Whatman 903 filter paper bonded to an underlying thin polyester carrier sheet are used, capable of taking up 100-150 uL of blood through a central open channel cut from the paper layer contacting the carrier sheet (and thus forming a tube with 3 paper walls and one polyester wall). The amount of desiccant required to efficiently take up the sample moisture is generally much larger in volume than the sample, and hence the desiccant material may be larger in volume and/or area than the sample vessel. In FIGS. 9 through 12, the desiccant comprises commercially-available beads of molecular sieve adhered to a carrier sheet, and positioned parallel with the sample vessel and spaced away from it by a small gap (e.g., 1-4 mm), facilitating the transfer of water evaporating from the sample onto the desiccant. Planar devices have several advantages in terms of manufacturability, in part because they are compatible with methods and devices used to make multi-layer sandwich devices such as lateral-flow diagnostic tests.

FIG. 12 shows the sample vessel and desiccant arrays of FIG. 11 (A showing a view from above and B a side view) positioned within a package that provides two additional functions. The package 52 has an area 55 comprising 3 thin layers that can be pierced by a lancet to puncture a subject's skin beneath the device. The top layer 55 is comprised of a self-sealing membrane (such as silicone rubber membrane); a lower layer 58 (against the skin), and a middle layer in which a fluid channel 56 is defined that runs from the puncture site to the entrance to the sample vessel 43. Prior to use, the outer surface of the lower layer 58 is protected by a removable sheet that covers a hole at the puncture site. Once the protective sheet is removed, exposing an external surface of lower layer 58 that is coated with an adhesive that reversibly adheres the device to the subject's skin. When the device is thus positioned on and adhered to the skin, a conventional lancet device (separate from the sample collection device disclosed here) can be used to punch a small hole through the silicone membrane and into the subject's skin. As the lancet is withdrawn, the silicone membrane re-seals, forming an impervious membrane through which blood will not leak. The device can include a means of generating or releasing a slight vacuum within the device, and this vacuum helps facilitate the flow of blood from the skin puncture, through channel 56 and into the sample vessel (absorber). Dome 56 represents one such vacuum-generating device: a stiff dome of plastic that can be depressed temporarily by the user (causing air to exit the device though a simple non-return valve) after which the dome springs back to its original shaped due to the material stiffness (or to an included spring), thus generating a partial vacuum inside the device. The device housing 52 can contain clear windows that allow visual observation of the blood filling the sample vessel, thus allowing the user to know when the sample vessel is filled and the device is ready to be removed from the skin. Finally a closure (e.g., an adhesive tape) is applied over the hole in lower layer 58, effectively sealing the entire device from the atmosphere before the sample begins to dry by evaporative transfer of water from the sample to the desiccant. Embodiments of this invention can be created by combining a pre-weighed sample vessel and a pre-weighed desiccant mass with the skin-surface blood sample collection technologies disclosed in patent documents by Seventh Sense, Tasso and other device makers. Additional embodiments can be created by combining the disclosed sample and desiccant devices with a computer-controlled sample collection assistance device (such as that shown in FIG. 7) in order to provide vacuum and record details of sample collection.

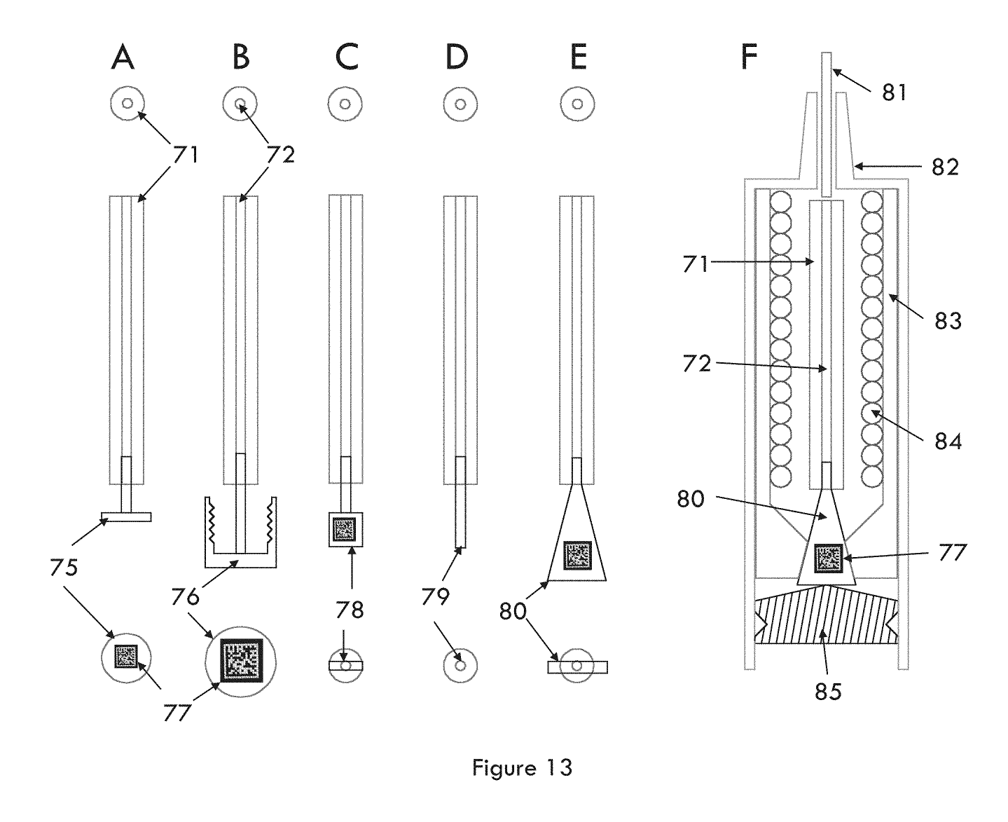

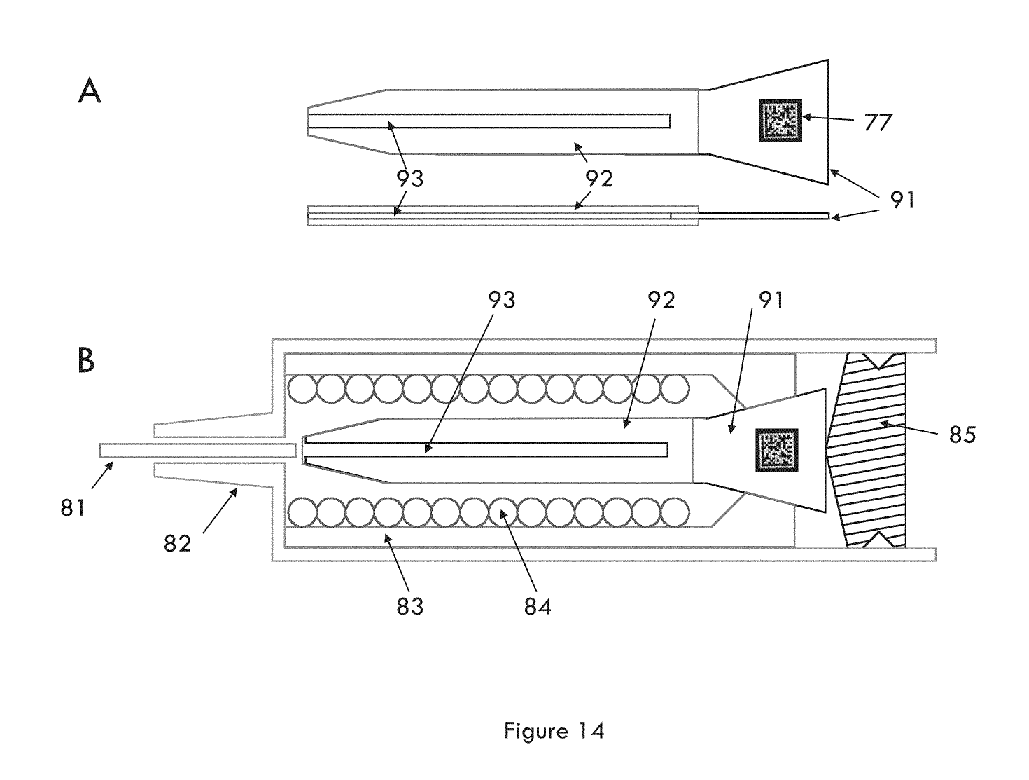

In a further preferred embodiment shown in FIGS. 13, 14, 15 and 16 sample is collected in two-part devices comprising a sample-absorbing porous material 71 with an internal capillary channel 72 joined to a rigid carrier 80. This two-part device is dried by placement in close proximity to a desiccant 84 which may be mounted on a desiccant carrier 83. The internal capillary channel allows sample (e.g., blood) to flow freely into the absorber from one end and to saturate the absorber without the sample having to flow through absorber material itself along its long dimension (long distance flow through a porous material slows the flow and progressively reduces the effectiveness of capillary action to transport fluid). The capillary thus assists in sample transport into the device and reduces the length through which sample must flow through absorber to half the difference between the inside and outside diameters of the cylindrical absorber tube. This feature dramatically improves the ability to collect larger samples by avoiding progressively slower inflow of sample during loading, or as sample viscosity increases due to clotting. The capillary effect desired can be achieved in a slot-shaped channel as well as in a “closed” tube with hydrophilic walls: if a slot is created in a sampling device such as that shown in FIG. 14A, e.g., by cutting through the absorbent layers as well as the support substrate, the surfaces presented by the cut absorbent render the sides of this channel predominantly hydrophilic and thus promote flow of an aqueous sample into and along the slot from which the sample can readily flow laterally into the planar absorber. The principle is similar to that of ink flow in a fountain pen nib. While the advantages of capillary flow through the lumen of an open channel are useful, the device can also function without such a channel, with sample flowing through the porous material to fill it.

FIG. 13A-E show a tubular sample absorber 71 mounted on different sample carriers: A) a thumbtack-like device 75 in which a projection is firmly seated in the lumen of the capillary hole of the absorber to join the two, and where a sample-identifying 2D barcode is printed on the flat face of the carrier to identify the absorber/carrier device and also the sample loaded onto it; B) a similar arrangement in which the carrier 76 is a screw cap with a projection for mounting the absorber and with a 2D barcode on the cap, such that the absorber can be inserted into and held within a threaded vial via the screw cap; C) a carrier 78 like A, except that the barcode is placed on a flat part of the carrier in the plane of the absorber axis rather than normal to is, so as to be readable from the side; D) an arrangement in which the carrier 79 is a simple rod, which may have a linear barcode printed along its length; E) a carrier 80 in which the projection for mounting the absorber is joined to a flat paddle carrying a barcode 77, and in which the paddle is tapered so as to engage a tapered slot in a collection device so as to locate the absorber in relation to other components. It is generally preferred that the diameter and length of the sample absorbers are chosen so as to fit within a vessel within which the dried sample is extracted for analysis (for example a well of a 96 well plate, in which case the absorber may be 3-5 mm OD and up to about 3 cm long.

FIG. 13F shows a sample collection device in which a cylindrical absorber 71 with capillary channel 72 is carried by a carrier 80, that engages with a desiccant carrier 83 mounted in the barrel of a syringe (housing 82). The desiccant carrier 83 carries molecular sieve desiccant beads 84 in close proximity to the sample absorber 71 but not touching it. The interaction between the tapered section of the sample carrier 80 and the desiccant carrier 83 is such that the taper of the sample carrier fits a tapered are of the desiccant carrier to keep the sample carrier centered in the bore of the device, preventing contact of sample with the desiccant, and aligning the sample carrier with a capillary 81 through which sample is introduced. In the embodiment shown, the end of the syringe barrel is closed by a rubber piston 85 similar to the rubber seal of a standard syringe plunger. The plunger can be introduced after the interior components are assembled in the syringe to seal the assembly and prevent gas or liquid entry other than by means of the entrance through which the capillary 81 enters, and the plunger can easily be removed to recover sample and desiccant carriers for sample recovery. As in earlier embodiments the amount of desiccant is selected so as to be capable of binding substantially all the water in the sample to be collected.

FIG. 14 shows a similar but distinct embodiment which, in panel A top and side views, the sample carrier 91 is a relatively rigid sheet of an inert material sandwiched between two sheets of porous material 92—the carrier sheet has an open slot 93 which, together with the absorber walls, forms a capillary slot through the open end of which sample can flow into the sandwich and wet the full length of the absorber. Porous material 92 can be a paper (for example Whatman 903 paper used in conventional dried blood spot cards) or a synthetic sintered material such as that used in Neoteryx Mitra collection tips. Carrier 91 can be any of a number of relatively stiff, biochemically inert materials including polypropylene and other polymers, glass reinforced plastics (such as fiberglass), glass, or metal (such as stainless steel or titanium). The porous material can be bonded to the carrier by various adhesives (e.g., pressure-sensitive adhesives used in the assembly of various diagnostic devices including lateral flow devices), staples, thread, or other fastening methods. The use of polypropylene or equivalent thermoplastics allows direct bonding of the carrier to the porous material by direct application of heat and pressure in a very simple and inexpensive manufacturing process. Alternatively capillary transport feature 93 can be a channel punched through all the layers (absorbers and carrier 91). The carrier in this case can also carry a barcode label on a paddle-like extension that may optionally have a taper to help in precise location of the carrier in a fixture or housing. In panel B the carrier/absorber sandwich fits snuggly into a tapered receiver in desiccant carrier 83, positioning the open end in close proximity to the point of sample entry (in this case a capillary 82). The whole assembly is contained within the cylindrical barrel of a syringe and held there by a plug 85, as in the previous embodiment.

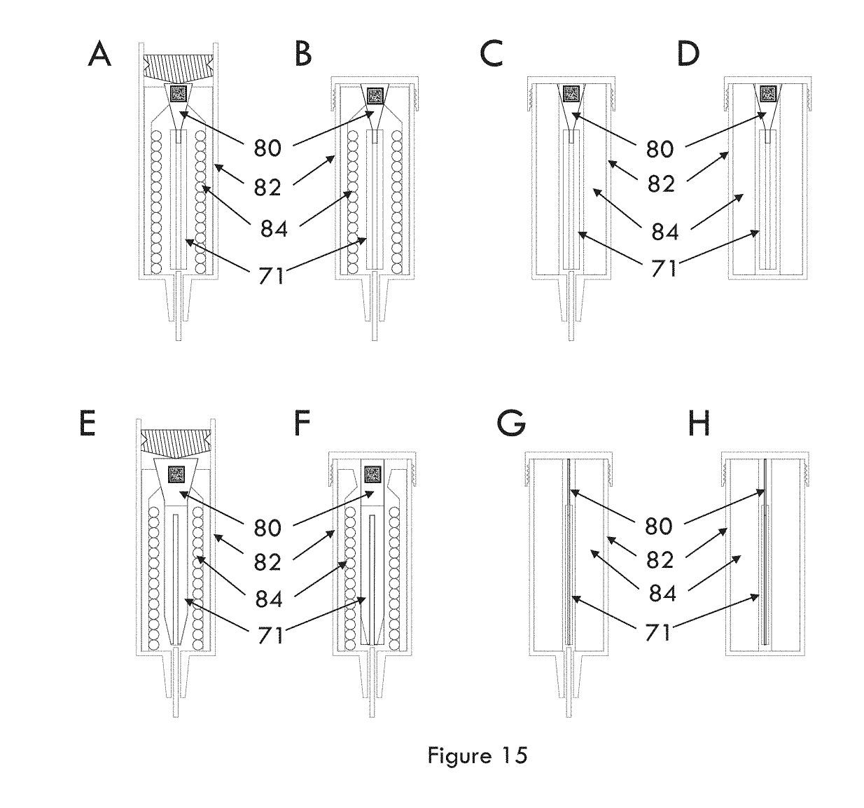

FIG. 15 shows a series of alternative configurations of the absorber and desiccant components described above. Panel A shows a configuration like that in FIG. 13F, Panel B shows a similar configuration in which the plug 85 is replace by a screw cap sealing the open end of the barrel. Panel C shows an embodiment in which the desiccant carrier and desiccant beads are replaced by one or more solid masses of desiccant (such as molecular sieve). Panel D shows a variant of C in which the syringe is replaced by a vial with screw cap. In this embodiment, the sample can be loaded into the absorber tube outside the vial, and then the absorber placed in the vial and sealed with a screw cap. Panel E shows an embodiment like that in FIG. 14B. Panel F shows a variant of E in which the syringe piston plug is replaced by a screw cap. Panel G shows a version in which the desiccant carrier and desiccant beads are replaced by one or more solid masses of desiccant (such as molecular sieve). Panel H shows a variant in which the syringe is replaced by a vial with screw cap. In this embodiment, the sample can be loaded into the absorber tube outside the vial, and then the absorber placed in the vial and sealed with a screw cap.

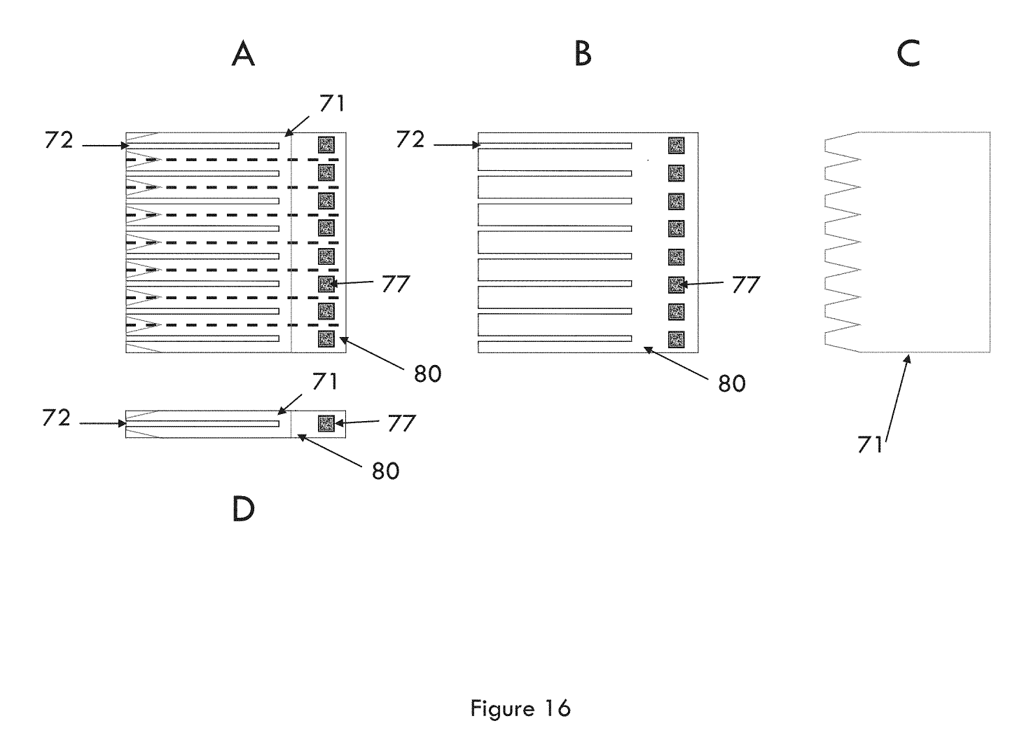

FIG. 16 shows a method by which the sample absorber/carrier sandwich of FIG. 14 can be manufactured using technology employed in manufacturing lateral flow diagnostic devices and similar laminated planar products. The general approach is to laminate large sheets or rolls of the required layers in bulk, and afterwards cut the material into individual devices. In one embodiment, two sheets 71 (Panel C), or equivalently two long rolls of sheet absorber material (for example Whatman 903 filter paper), are prepared with notches cut into one edge. A sheet 80 (Panel B), or equivalently a long roll, of relatively rigid carrier material (for example a plastic such as polypropylene) is prepared with slots 72 cut in from one edge serving as capillary channels to aid in flow of sample along the device. Alternatively these slots can be omitted prior to lamination and instead narrow slots can be cut in the sandwich after lamination (these slots having a width preferably in the range 0 to 1.5 mm width). A series of unique barcodes 77 (in this case 2D barcodes) is printed on the sheet before assembly (or alternatively after assembly). Next the three sheets are assembled as a sandwich (Panel A) of absorber on the bottom, carrier in the middle and absorber on top, and these layers laminated together using heat (to partially melt the plastic carrier), an inert adhesive or other bonding means (staples, rivets, sewn seams, etc.). Finally the individual devices shown in Panel D are prepared by cutting the laminate into strips along the dotted lines in Panel A. Such a lamination process can be run as an essentially continuous process, allow devices to be made at very low cost. According the invention, each device is identified by a unique computer readable code (here a 2D barcode) and is weighed during manufacture (or produced by a process guaranteeing a precisely known weight) so as to establish a tare weight in a computer database. Preferably the tare weight is determined with high precision and accuracy in order to provide an accurate tare weight for subtraction from the weight after addition and drying of sample (and subsequent calculation of sample weight and estimation of sample volume using known sample density). The tare weight is preferably determined within +/−2mg (approximately equivalent to 2 uL of aqueous sample such as blood); more preferably within +/−1 mg; more preferably within +/−0.5 mg; and still more preferably within 0.2 mg. This tare weight can be used later to determine the weight of dried sample collected on the device as described elsewhere in this disclosure. Likewise the desiccants and desiccant carriers of this embodiment can be tared during manufacture and later weighed to determine the weight of water extracted from the sample during drying in the closed vessel, preferably with similar precision to the measurements of the sample device.

In the above embodiments that utilize a syringe barrel as the device housing, the syringe can be connected to a source of sample (e.g., blood) through a Luer (or equivalent) liquid connection as is commonly employed with syringes of all kinds. A small diameter capillary 81 can be used to introduce liquid through the opening in such a Luer connector, or sample can be aspirated directly from a liquid sample source (a vial of sample or an intravenous line) by pulling on the piston plug 85 by means of an attached handle typical of a syringe plunger. After sample is loaded into the absorber, and after the capillary 81 is removed, a standard Luer cap or other airtight closure is applied to the Luer opening to render the device closed to surrounding air.

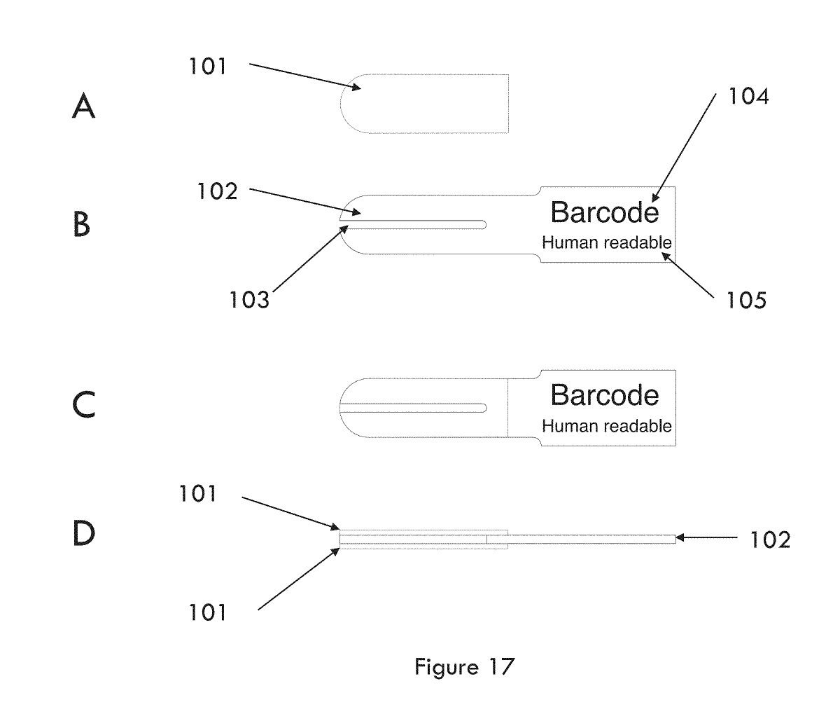

A further refined embodiment of a planar laminated sample vessel (sample absorber) is shown in FIG. 17. An inert, relatively rigid planar substrate 102 (panel B) is laminated with two pieces of porous sample absorber 101 (Panel A) to form a 3-layer sandwich (panel C—top view; panel D—side view). The end of the device distal to the absorbed sample (i.e., the right side in the drawing) preferably carries a computer-readable barcode and a human readable identifying code (which is preferably the same identifier as represented by the barcode). The device can be handled by the barcoded end without contaminating the sample end.

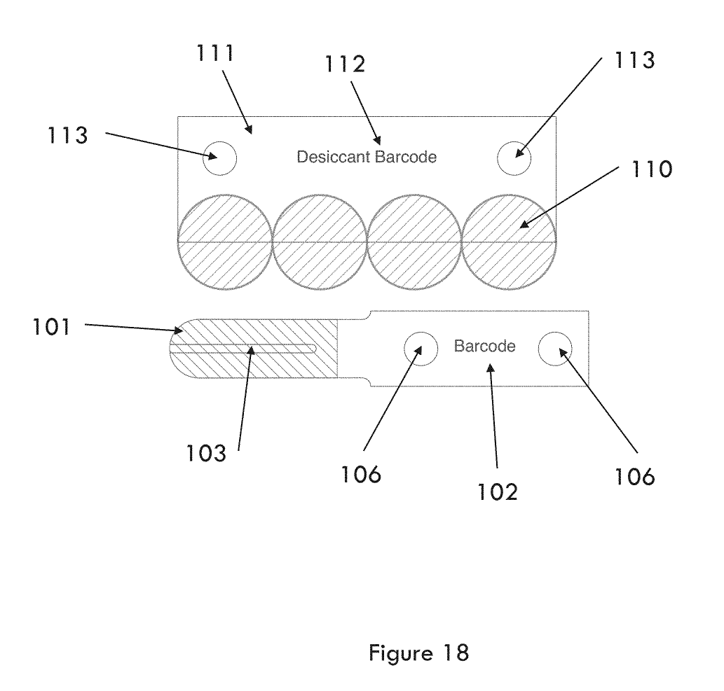

FIG. 18 shows the sample containing device of FIG. 17, consisting of planar substrate 102 carrying layers of porous sample absorber 101, and which in this embodiment additionally has two holes 106 that can engage with locating pins in housings used in sample collection and later in automated device handling. The figure also shows the accompanying desiccant 110 required to absorb the sample water, with the desiccant mounted on a sheet of material (the desiccant carrier 111) to allow its easy manipulation and positioning. In this version the desiccant is molecular sieve formed into tablets (in this case circular tablets of molecular sieve 4A such as Sorbent Systems part 618TMS01) which are bonded to the desiccant carrier, preferably on both upper and lower surfaces, providing a total of 8 such tablets in the configuration shown. The desiccant carrier preferably carries a unique barcode allowing each individual device to be associated with a tare weight obtained before exposure to sample water.

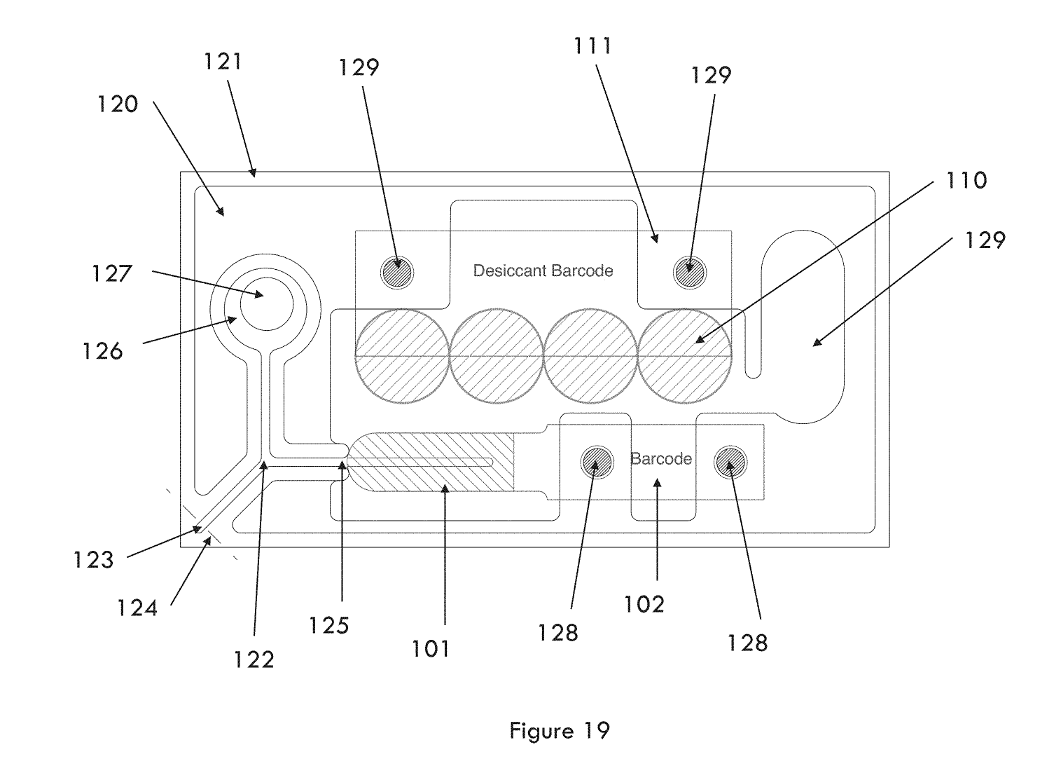

FIG. 19 shows the devices of FIG. 18 positioned in a package for use in collecting blood samples. The device 120 is formed of two sheets of thin vacuum-formed plastic (such as PETP, polypropylene or the like) that are joined together to form an airtight seam 121 (e.g., by friction or ultrasonic welding, or by use of adhesives) around the edge of the device. The seam extends into the device to define internal flow channels communicating from point 123 via channel 122 to orifice 125 (in close proximity to the sample introduction end of sample absorber 102 carrying porous material 101) and to an optional closed side-compartment 126. The sample absorber 102 is located in the device by engagement of protruding posts 128 with holes 106 (FIG. 18). Likewise desiccant carrier 111 is located in the device by engagement of protruding posts 129 with holes 113 (FIG. 18). The exterior seam renders the device airtight after manufacturing. Prior to use, a user clips the edge of the device (e.g., with scissors or a nail clipper) along dotted line 124 to open capillary channel 123. When the end of this capillary 123 is exposed to a liquid sample such as blood, the sample flow through capillary action into the device, past 122, to 125 and then into the porous material 101 on the sample carrier. Use of a clear plastic to form the upper layer of the device allows a user to see when the absorber is filled and cease providing more sample. The device optionally contains an empty reservoir 129 which can be pressed to expel a small volume of air through opening 123 before sample entry, and then released when sample begins to enter the device, thereby generating a small pressure differential that sucks sample into the device. The device can then be placed in a sealable bag (e.g., a Ziplok bag) or optionally the channel 122 can be occluded by pressing on reservoir 126 which has been preloaded during manufacturing with a small quantity of an inert wax or grease 127, which under pressure flows from reservoir 126 to 122 and then partially fills the capillary lumen between 123 and 125. Once sealed, sample water diffuses through the air contained inside the device to be captured by desiccant 110, rendering the sample constituents stabilized during transport and storage. Prior to analysis, the device is sliced open and the sample carrier is extracted and weighed, as is the desiccant carrier, the resulting weights being compared with pre-recorded or otherwise known individual tare weights to determine the sample dry weight and the weight of the water the sample initially contained.

The housing shown, typically about the size of a credit card, can be molded, or machined, or more preferably vacuum formed from thin sheets of a thermoplastic plastic. In the design shown, the device is approximately 8 mm thick at its thickest point, with all the edges shaped so as to meet and form a seam all around the periphery. Internal void spaces around the components inside the housing allow space for sample water to diffuse through the air from sample carrier to desiccant, drying the sample inside the device.

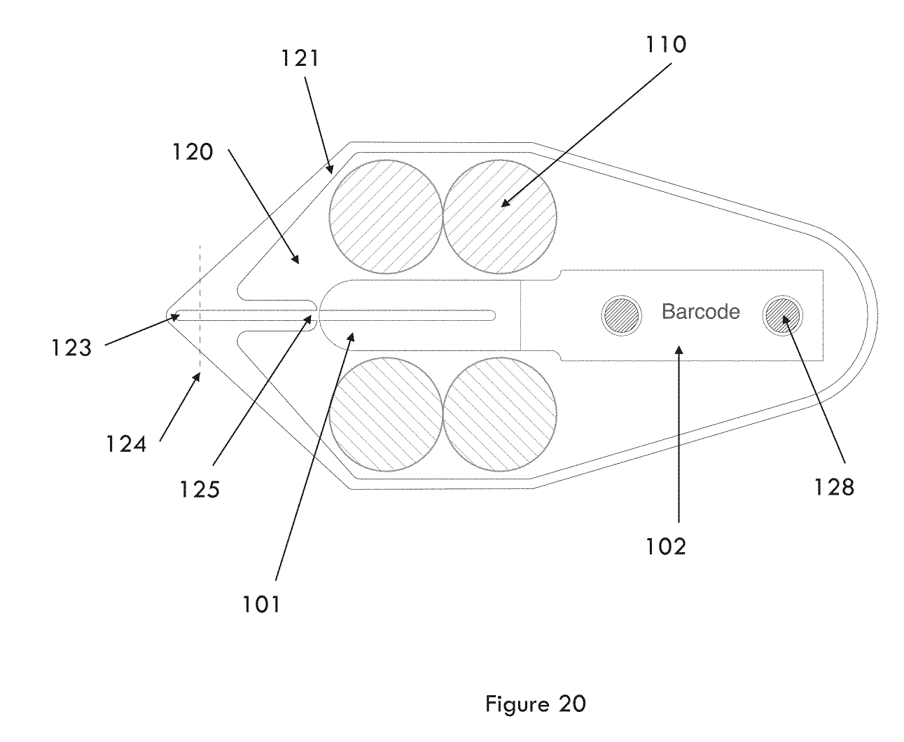

A similar but simpler version of the device of FIG. 19 is shown in FIG. 20. As in FIG. 19 sample carrier 102 is located on posts 128, with the entry to the sample carrier in proximity to the end 125 of a capillary channel formed as part of the seam 121 holding together a housing consisting of two vacuum-formed sheets of plastic. In this case the desiccant, in the form of tablets, is held in place either by adhesives or by press fitting into depressions formed in the housing. As in the earlier embodiment, the device is used by cutting the housing along line 124 to create an opening into which a liquid sample can flow under the influence of either capillary forces or because of a partial vacuum created in the device by squeezing together a part of the device and releasing it once the open end of channel 123 contacts sample.

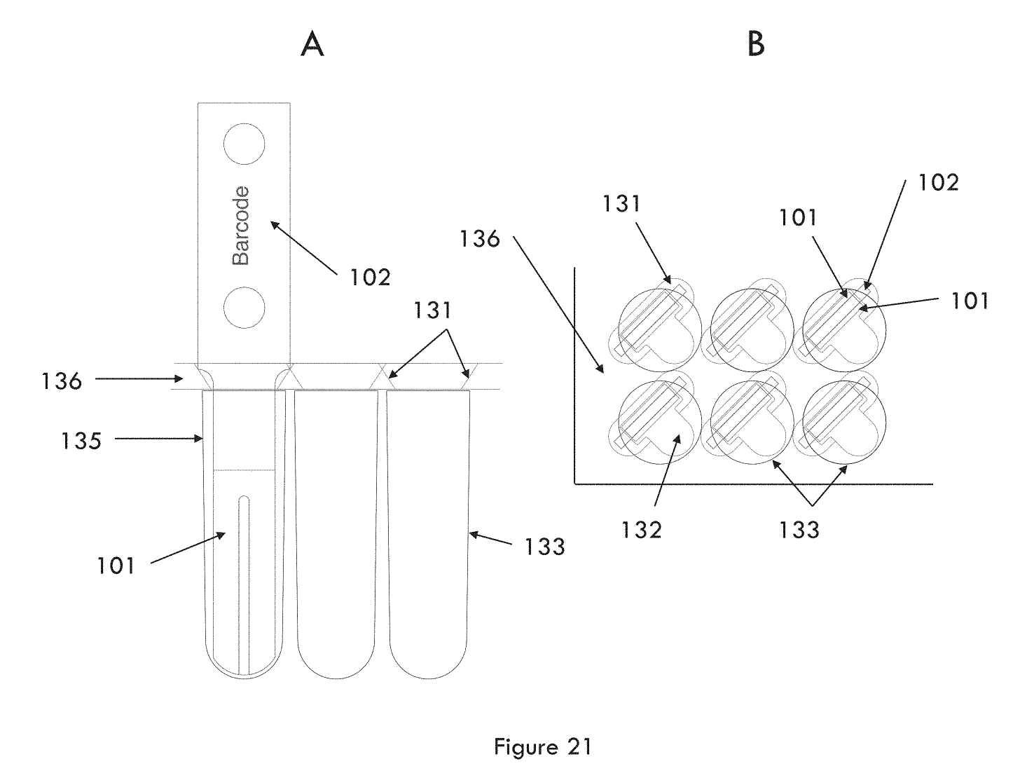

FIG. 21 shows the positioning the sample absorber region 101 of a sample carrier 102 (as shown in FIG. 17-20) in a well 133 of a 96-well roundbottom deepwell plate as an initial step in extraction of dried sample components for analysis. A positioning plate 136 with 96 apertures (openings 131 and 132) is placed above the 98-well plate. Above each well 133 is an aperture comprising a slot 131 sized to permit passage of the narrow, sample bearing end of the sample carrier (carrier 102 with laminated porous sheets 101) but not the wider end of the carrier (the end with the barcode). The slot is chamfered to guide the sample carrier during vertical insertion into the plate. An additional hole 132 in the positioning plate 136, shown here communicating with the slot 131, provides access to the well for delivery of liquid reagents used in sample processing. Reagents can thus be added by a manual or robotic liquid pipetting device through holes 132, up to level such as 135 that covers the sample absorbers and allows efficient extraction of the dried sample therein. After the appropriate steps in a sample extraction protocol, the positioning plate can be lifted slowly upwards, removing the sample carriers from the 96-well plate while remaining liquid drips back into the plate, and the positioning plate finally moved to the side (preferably using a drip tray to prevent contamination between samples and wells) and the sample carriers removed. This process can be repeated to extract different analytes, for example by extracting the sample carriers with an organic solvent first (to elute small molecule metabolites, drugs, etc.) and subsequently moving the positioning plate and sample carriers to a different 96-well plate to extract proteins (e.g., via tryptic digestion). In the figure, the slots in the positing plate are arranged at a 45 degree angle to allow better packing of the sample carriers without mechanical interference.

In the devices described above, the desiccant is preferably an efficient desiccant such as molecular sieve 4A Blue Indicating Molecular Sieve Desiccant (Delta Absorbents) or tabletized molecular sieve 4A (Sorbent Systems). The amount of desiccant is carefully established so as to ensure that it can remove essentially all the water from the sample and render the humidity of the closed container very low (preferably below 20%, below 10%, below 5%, below 2% or below 1%) following a relatively brief period (preferably less than 24, less than 6 or less than 2 hours). Suitable molecular sieve desiccants having a physical density of −0.6 are typically able to tightly bind water equivalent to up to 20% of their dry mass (or 12% of their equivalent volume). Hence it is possible to compute an amount of desiccant required based on the known water content of the desired sample volume (blood is typically about 80-90% water) and the specific properties of the desiccant selected. For molecular sieve 3A a volume of desiccant greater than approximately seven times, and preferably ten times, the volume of blood is used to dry the sample effectively. In the case of human blood, the sample may be considered dried from a sample preservation viewpoint when 70%, or preferably 75%, 80%, or 85% of its weight has been removed by evaporation of water. Typically blood contains 85% to 90% water and so even when 80% of the weight has been lost, a significant amount of residual water remains in the sample, presumably bound to protein and other apparently dry solutes. Many desiccants are available in a form that includes a humidity indicator (frequently a blue color that turns to pink or beige when the desiccant has absorbed its useful capacity of water)—such an indicating desiccant is preferred since it allows a user to know that the desiccant is active (i.e., blue) when the sample is loaded onto the absorber, as well as showing that the desiccant retains some additional capacity after the sample has been dried (and hence can maintain a low humidity in the sample vessel during storage and transport). A molecular sieve desiccant can be used in the form of beads or powder (contained behind a porous barrier so as not to be present in the sample vessel at the time of sample dissolution for analysis), or in the form of a shaped tablet or tube. For robustness and handleability, the desiccant may be designed, for example, to fit within a desiccant vessel where it is held in place by a friction fit or adhesive. The desiccant vessel may be sealed from the atmosphere until use to prevent premature collection of atmospheric water, for example by storage tightly assembled with the sample vessel, or as a separate component sealed by a removable water-impermeable membrane tab that prevents entry of water into the desiccant prior to sample loading. In the latter case, once this tab is removed, the desiccant vessel is screwed onto the sample vessel creating a closed container in which water is transported through the air from the sample being dried to the desiccant. Using a sufficient quantity of desiccant the sample can be rapidly dried, stabilizing it for later analysis.

The device of the invention makes possible a novel and convenient method of collecting samples. In the case of finger prick blood samples, a device like that of FIG. 8, 9, 10, 12, 14, 19 or 20 is placed on its side so that the capillary is approximately horizontal. The device of FIG. 9 has one flat side on which it can be rested on a table to facilitate its orientation with a clear strip of the wall of the vial 52 aimed upward, giving the user a clear view of the sample vessel capillary 40 when loading blood into the device. A conventional lancet device is used to prick a fingertip of a sample donor, and a blood drop emerging from the finger is contacted with the open end of the capillary extending from the device. Blood is drawn into the capillary sample vessel by capillary action, which is allowed to continue until the capillary is filled.

In the devices shown in FIGS. 2,3, and 4, the filled capillary is then moved so that an end comes into contact with the absorber, after which the absorber absorbs the blood, emptying the capillary. This movement of sample from capillary to absorber may be accelerated by reorienting the device so that the capillary is near vertical, with the absorber below the capillary so that gravity aids the movement to the absorber. Once the capillary is emptied of sample, the capillary can be removed from the device (alone or as part of a sample applicator assembly as in FIG. 2), and the desiccant vessel is attached to the sample vessel with a tight seal (for example a screw connection with a gasket, or a tight friction fit). Alternatively, a capillary mounted in the desiccant vessel can be left in place. Once the two vessels are in tight communication, water evaporating from the sample is bound tightly by the desiccant and drying of the sample proceeds to a point at which sample constituents are stable, typically resulting in the humidity in the joined vessels falling to less than 10% in a few hours.

Sample dried at low humidity in the closed combination of sample+desiccant vessels is stabilized and can survive storage and transportation unrefrigerated for days or weeks, and can be stored for very long periods frozen at −20 C, −80 C or in liquid nitrogen.

In preparation for sample analysis, the sample and desiccant vessels are separated. In a preferred embodiment, the sample vessel is placed in a rack or well-plate compatible with spacing in conventional 96 well plates (i.e., a 8×12 array on 9 mm centers), facilitating addition of liquid reagents, etc., using a laboratory liquid-handling robot. Depending upon the design and size of the desiccant vessel, it may be removed from the sample vessel either before insertion of the sample vessel into the rack or afterwards, either manually or by an automated extraction device. The identities of the individual samples inserted into the rack are established by scanning computer-readable codes (e.g., 1D or 2D barcodes) on each sample vessel from beneath the rack (or alternatively by scanning computer readable codes positioned anywhere on the sample vessels or carriers either before or after insertion into the rack). Initial steps of sample preparation, which may include dissolution of sample solids from a dried state and protein digestion, may be carried out in the sample vessel without the need to remove the imbibing zone and its cargo of dried sample.

In addition to a quantity of desiccant, an oxygen absorber (powdered iron or preferably a polymeric oxygen absorber that does not release water) may be included in or with the desiccant vessel in order to eliminate free oxygen in the vessel after sample collection, thereby reducing the potential for chemical oxidation of sample molecules during storage. Minimizing post-sample acquisition oxidation of protein methionine residues for example, can help preserve potentially relevant biomarkers related to in vivo methionine oxidation.

In a preferred embodiment related to protein analysis, a blood sample dried in a sample vessel is prepared for digestion by dissolution, denaturation, reduction and alkylation. The purpose of such treatments is to open up the compact structures of the proteins, dissociate protein complexes and render each appropriate cleavage site (in the case of trypsin most lysines and arginines in the protein sequence) available to the proteolytic enzyme for cleavage. Since cystine intra- or inter-chain disulfide bonds play a major role in inhibiting protein unfolding, the reduction of cystine to two cysteines residues, and the modification of the resulting cysteines so as to prevent reformation of cystine bridges, are desirable steps in the sample preparation process. Briefly, each sample is subjected to dissolution by addition of liquid and shaking; dissociation (e.g., by addition of urea or deoxycholate); followed by cystine disulfide reduction (by addition, in minimal volumes, of dithiothreitol, mercaptoethanol or TCEP to a concentration of 2-4× the concentration of sample cysteine thiols, estimated at 26 mM in plasma before dilution), and, after incubation for 30 min (typically at 60° C. in the case of deoxycholate denaturation), alkylation of cysteines (by addition, in minimal volume, of iodoacetamide, iodoacetic acid, or the like, to a concentration 2× that of DTT just added) and incubation in the dark. Shaking the plate and included sample vessels significantly improves the rate and completeness of sample dissolution, particularly when an orbital shaking motion is used. In a preferred embodiment, dissolution, denaturation and reduction are carried out in one step, for example by addition of 280 μl of 2% deoxycholate, 1.7 μmol of TCEP in 0.25M Tris buffer pH 8.5 followed by vigorous shaking on an orbital plate shaker for 30 min at 60° C. Alkylation is then performed by addition of 3.4 μmol of iodoacetamide in water followed by incubation for 10 min the dark. Tryptic digestion is then carried out by addition of 360 μg of trypsin in 1 mM HCl, followed by shaking incubation at 40 C for 1 hour. Through this point, all steps can be carried out in a liquid holding vessel with the imbibing zone absorber in place, thereby avoiding any potential loss or fractionation of sample prior to analysis. After extraction of sample from the sample absorber, the absorber can be removed from the vessel now containing the redissolved sample contents, preferably using an approach that reduces liquid remaining in the sample absorber (and thus removed from the sample used for analysis), for example by slowly lifting the sample absorber from the vessel so as to drain its imbibed liquid into the vessel, or by lifting it above the sample vessel and centrifuging the vessel and absorber so as to move any remaining liquid from the absorber to the vessel. Removal of the sample absorber from a vessel holding extracted sample contents preferably occurs after addition of any internal standards used in subsequent analytical measurement processes so as to preserve the desired ratio between added standard and total amount of sample.

Stable isotope labeled SIS internal standards, in the form of labeled peptides or proteins, may be provided dried in the imbibing zone to act as internal standards throughout acquisition, drying, storage and subsequent processing of samples. Their stability is improved by the fact that very low humidity is maintained in the vessel by the included desiccant prior to introduction of sample (which dissolves the SIS, after which it is re-dried after combination with sample). In a preferred embodiment, the absorber sample vessel is used as a Carrier as described in patent application PCT/US11/28569 herein incorporated by reference in its entirety, to which one or more extended SIS peptides are attached by a proteolytically-cleavable linkage.

In a further preferred embodiment, the digested sample is subjected to SISCAPA enrichment of specific target peptides prior to mass spectrometric analysis. A preferred form of SISCAPA protocol employs anti-peptide antibodies immobilized on magnetic beads to capture target peptides and remove them from the digest. The magnetic bead capture may be carried out in the presence of the original sample vessel, after which the beads can be removed by magnetic capture (e.g., using a Thermo Kingfisher robot), or the digest liquid may be transferred to a fresh vessel in which the SISCAPA capture, washing and elution steps are carried out so as to minimize any losses of magnetic beads adhering to or trapped within the sample absorber.

In a further preferred embodiment, the sample absorber is made of a hydrophilic foam, sponge or meshwork that dissolves during the sample preparation workflow. For example, the absorber can be made of a gelatin sponge material similar to the absorbable gelatin sponges used for hemostasis in surgery. Such a sponge is made of a protein (typically porcine gelatin) that is cleavable by trypsin and thus will dissolve during the digestion phase of the SISCAPA protocol. Digestion of the porcine gelatin (a form of collagen) creates additional tryptic peptides in the sample, but these are typically of low abundance (aside from collagen peptides) and typically have sequences differing from targeted human biomarker peptides, and thus do not interfere with quantitation of human biomarkers. Dissolution of the sample imbibing zone (the absorber) results in a fully liquid sample digest, and avoids any trapping of sample molecules that could occur within an imbibing zone the persists intact in the sample vessel during and after sample preparation. Alternative dissolvable absorbers include polymeric sponges cross-linked by disulfide bonds that are disrupted (and made soluble) upon reduction of protein cystines during sample preparation, and gels or sponges that can be rendered soluble by heating the sample.

The device and methods described offer the possibility to retain the sample in one container (the sample vessel) from the time of collection, during storage and transport, during sample preparation for analysis, and possible post-analysis storage, without the needed to separate, aliquot or otherwise divide the sample contents. In the SISCAPA approach, for example, only designated analyte peptides are removed from the sample, leaving essentially all other sample components, including other biomarkers, available for later analysis. Hence it is attractive to retain the processed sample in the original sample vessel in case of future need to measure additional biomarkers, and this is facilitated by the sample-specific barcodes and convenience of 96-well format rack storage. Processed samples, including proteolytically digested samples, can be stored frozen for extended periods, and are known to be useful for later extraction of additional analytes. Individual sample barcodes also facilitate recovery and re-arraying of specific samples from storage for later analysis, either by manually picking individual sample vessels or through use of an automated sample vessel picker.

A series of useful additional features can be optionally included in the devices of the invention. These include:

Sample and desiccant vessels can be joined by a friction fit or by screw threads. Sample and desiccant vessels can be sealed when joined by a variety of gasket, O-ring or interference fit methods.

Sample can be introduced into the imbibing zone of the sample vessel by dispensing from a user operated micropipette (e.g., an Eppendorf pipette) rather than a self-filling capillary.

Denaturants (e.g., deoxycholate or urea), disulfide reductants (e.g., tris [2-carboxyethyl] phosphine (TCEP)) and/or buffers can be pre-positioned on the sample absorber by drying a solution of these components on the absorber, so that after absorption of the sample, theses reagent dissolve in the sample before it is dried in place by the desiccant.

Important advantages of the disclosed invention are:

An approximately known volume of sample is collected by virtue of the geometry of the measuring sample vessel capillary, and the precision of the sample amount value can be substantially increased using the measured weight of sample, sample solids and sample water available through use of the invention.

Sample is dried on a stable matrix such as paper, paper having been shown to be a stable medium by long experience

Drying, as well as storage at very low humidity, is ensured by sealing the sample vessel in communication with a quantity of high efficiency desiccant such as molecular sieve that is known to be sufficient to dry the collected volume of sample.

The dried sample does not need to be handled, cut, punched or manipulated to get it into a tube for digestion and further processing.

The volume of sample that can be accommodated in a sample vessel compatible with the 96 well format is greater than can be conveniently inserted as one or more punches from a conventional DBS card.

The sample vessel fits in a 96 well format for automated processing.

The imbibing zone is positioned at or near the vessel wall so as to allow efficient dissolution of sample by shaking, and also avoiding interference with a pipette introduced on the vessel axis in the event dissolved sample or sample digest needs to be removed as part of pre-analytical processing.

Further improvements in sample collection, storage, analysis and record keeping are made possible through use of the device.

### Weighing to Determine or Confirm Sample Load

In various embodiments, the tare weight of the collection vessels or devices or parts included therein are within or +/−3 mg, +/−2 mg, +/−1 mg, +/−0.5 mg or +/−0.1 mg (corresponding approximately to 3, 2, 1, 0.5 or 0.1 uL of sample). In a further embodiment, an entire lot of devices manufactured for, selected for and/or sold to a customer is within such a tare weight range. Such a lot may be more than two, more than 10, more than 100 or optionally between 2 and 100, 1000, 10,000, 100,000 or 1,000,000 devices. Device lots can be made within such tare weight precision or range by a variety of methods including 1) precision manufacturing such that all devices are created with a reproducible tare weight; 2) selection of a subset of manufactured devices that fall within the tare weight range when measured after manufacturing, and 3) adjustment of tare weight after manufacturing to achieve a weight within a tare range by removal of material from a device (e.g., by laser ablation) to reduce initial tare weight to a value that is within the tare weight range upon re-weighing, or by addition of material (e.g., by addition of a drop of thermoplastic, glue, etc.) to increase initial tare weight to a value that is within the tare weight range upon re-weighing. The design of the devices and their packaging is preferably such that contamination during transport, use and subsequent handling by material other than sample or sample water (e.g., dirt, fingerprints, dust, etc.) is minimized.

Given the individual identification of each sample collection device (e.g., by a barcode on the sample vessel) it is practical to either manufacture the device and optionally any parts therein so as to achieve a precise reproducible weight, or to weigh each individually labeled device and record the weight at the time of manufacture (this is the “tare” weight of the vessel and its contents prior to sample loading). The inaccuracy of this tare weight is preferably less than the acceptable variation in the weight of the sample that is to be determined; hence for accurate measurement of the weight (or nearly equivalent volume) of a 50 μl blood sample (weighing slightly more than 50 mg), in which a +/−1% error is acceptable, the weight should preferably be accurate within 1% of 50 mg, or +/−0.5 mg. More accurate tare weights are desirable since they enable more accurate measurement of sample dried on the device, and are particularly useful when smaller sample volumes are collected: if the device is used to collect only 10 uL of sample (which can be the case when only a small amount of capillary blood is available from a lancet puncture) then the tare weight should be accurate within +/−0.1 mg in order to enable +/−1% accuracy in sample amount. Since one important objective of a pre-determined tare weight is to improve upon the reproducibility in sample mass compared to either 1) a conventional dried blood spot punch having a typical imprecision of +/−10% in sample amount, or 2) a Mitra device having a reproducibility of approximately +/−3-5%, the tare weight measurement should be more accurate than 3% of the sample volume, which in turn is approximately 3 mg for a 100 uL sample and 0.3 m for a 10 uL sample. Tare weights can be obtained and recorded for the sample vessel, for the desiccant vessel (in which case it can be helpful to include unique codes on the desiccant vessels), and for the two vessels together. The tare weights are recorded in association with the vessels' unique codes in a computer-readable form so as to be retrievable at the start of an analytical process in which the samples will be used, or alternatively the tare weight can be recorded on the device itself, e.g., as a barcode. Electronic balances are available that can weigh objects like these sample and desiccant devices on a production line basis with sub-milligram accuracy (e.g., the Mettler Weigh Module WMS404C providing 0.1 mg repeatability). In combination with robotic means for rapidly handling the vessels and scanning associated identifying barcodes, existing technologies can provide a very practical, rapid and economical means of establishing the desired weight data, both at the time of manufacture (or any time before use) to establish device tare weights and after sample has been loaded into the device (but before sample analysis). The precision obtainable by this approach exceeds the precision of most available practical means for measuring sample volumes in the laboratory or in the field. In particular this approach can reduce the sample volume error to substantially less than the 3% to 10% volume variation characteristic of the current devices and methods for collection of dried blood samples. Since current methods of measuring amounts of biomarkers such as proteins in serum or plasma can achieve precision (as coefficient of variation CV) of <5%, <3%, <2% and in some cases <1%, the translation of this precision onto a conventional concentration scale requires knowledge of sample volume to similar or better precision., as provide by the present invention.

After application of sample to the sample vessel (or sample absorber), and subsequent drying of the sample by extraction of the sample water onto the desiccant, either the sample vessel or the desiccant vessel (or both) can be weighed again, for example immediately before beginning the analytical workflow. The difference between the sample vessel's tare weight and the vessel's weight with dried sample inside is a good estimate of the weight of dry solids in the original sample (this estimate can be improved slightly by use of a correction for an amount of water remaining in the dried sample derived from studies of the device's performance, including the humidity level achieved when dry at steady state). Similarly, the difference between the tare weight of the desiccant vessel and this vessel's weight after the collected sample is dry provides a good estimate of the amount of water in the sample. The difference between the weight of the assembled device (sample vessel plus desiccant vessel, or e.g., with respect to the desiccant of FIG. 8, the desiccant tare weight, including any desiccant packaging material) before and after introduction of the sample equals the weight of the sample (the sum of its solids plus water). Any two of these difference measurements allows computation of the third (i.e., sample weight minus sample dry weight equals sample water weight).

The total weight of the sample placed in the device is important whenever the device collects an amount of sample that is not precisely known at the time of collection—e.g., when sample is collected “in the field” or by a non-expert user without use of a rigorous volume-defining protocol (such as pre-collection in a calibrated capillary). Thus the sample weight measured by weighing the tared sample device (or its various tared components) can be used to calculate a precise estimate of the volume or weight of sample collected. The density of blood is approximately 1.06 and generally varies little from this value, allowing the volume of a blood sample to be calculated by dividing the weight in milligrams by 1.06 to yield the blood sample volume in microliters.

As discussed in the Example related below and shown in FIG. 10, blood placed in a paper capillary tube 40 rapidly dries when placed inside a closed vessel 54 together with beads of molecular sieve desiccant 43. Approximately 80% of the sample mass is transferred to the desiccant within 24 hours. While this is sufficient to dry the sample as needed for its preservation, it does not represent all the water in the blood sample (which would be expected to represent about 88% of the weight, blood containing about 12% dissolved solids). It is assumed that at least some water is bound tightly by proteins and other solutes in the blood, and some may be sequestered physically when blood dries on the surface of the sample vessel.

The performance of the disclosed devices can be calibrated with respect to water retained by the dried sample by determining the water remaining in the dried sample—e.g., by use of classical chemical determination of residual water (by Karl Fisher determination), or by further extensive drying at high temperature or under vacuum. Such a calibration can take into account not only the amount of sample added but also the length of time the sample remains in the device, and is designed to provide an estimate of the total mass of solids present in the sample, and (using the total water content), the amount of solids dissolved per unit of water in the sample. Hence a calibration table or equation is made is made that, for any measured weights of dried sample and associated desiccant-captured water, provides a reliable estimate of the total dry mass and the total water mass present in the original sample (i.e., as if the sample had been taken to absolute dryness). These calibrated values provides an improved means of normalizing the abundances of specific biomarkers and other constituents of the sample—constituents whose concentrations can be affected, for example, by changes in the total water content of the blood in a person that occur due to changes in posture, weightlessness, dehydration (e.g., from exercise) and in disease. By effectively normalizing biomarker concentration as a proportion of total blood dissolved solids, or alternatively the total volume of the sample, these variations can be removed, and more precise estimates of biomarker concentration in an individual over time can be made. In such a normalization, three related measurements (total sample weight, total weight of sample dissolved solids and total sample water, as weight or calculated volume equivalent) are obtained, the total sample weight being equal to the sum of solids and water weights. In a preferred embodiment, the weights of the sample vessel and desiccant are measured after sample drying and before sample analysis in order to calculate total sample weight, and to derive final sample dry weight and final sample water through application of the calibration strategy described. This approach avoids reliance on direct measurement of the total weight of the device with sample, which could be affected by contamination of the exterior of a device during handling or shipment.

In a variant of the process described above, the desiccant inside the sample collection device is unable, for whatever reason, to dry the sample to the desired dryness. In this case, the sample carriers (or vessels) can be further dried upon receipt in a processing laboratory using bulk systems to achieve a measurable humidity of water content, and the sample devices weighed after this additional drying step to determine dry sample weight. In a limiting case, the sample is not dried at all between collection and analysis, but is dried after receipt for processing and weighed afterwards to determine sample dry weight.

A further valuable refinement of the biomarker concentration normalization can be made when estimates of the relative amounts of plasma and cellular compartments are available (essentially equivalent to the classical hematocrit (Hct) measurement. Such an estimate can be obtained by measuring the relative amounts of biomarkers that are characteristic of the plasma and cellular (mostly red blood cell) compartments as described in U.S. Pat. No. 9,588,126. The ratio of these compartments allows the total blood dissolved solids to be further divided by attributing them proportionally to plasma and cellular mass components. Using such a calculated plasma dissolved solids mass as a normalizing factor, measurements of plasma biomarkers can be even more precisely estimated in samples collected, for example, over time from an individual whose hematocrit may vary. Similarly biomarkers present in blood cells can be better normalized using as a normalizing factor the total mass of dissolved solids attributable to blood cells. In both plasma and cellular components of the sample, protein is expected to make up the majority of this weight.

Measurements of sample dissolved solids could also be obtained by using a sample vessel tare weight obtained after removal of sample from the sample vessel (e.g., after sample solids have been redissolved and the same vessel subsequently dried to a “clean” state) rather than prior to loading of sample into the sample vessel. This approach is less preferred as it requires substantially complete removal of dried sample from the same vessel—something that is likely to be difficult to achieve reliably in practice.

Major advantages of the availability of the vessel-associated pre-sample tare weights are 1) the ability to measure sample mass accurately at the time of analysis (or before if needed), thereby eliminating analyte concentration errors associated with uncontrolled variation in the amount of sample actually collected; 2) the ability to verify that the amount of sample is within a desired quality-control window around an expected value (i.e., was sufficient sample collected to allow accurate measurement of the desired analytes?); and 3) the ability to measure the fractional water content of the sample (which may be used to estimate blood total protein content through use of an empirical calibration scale, and to compensate for analyte concentration errors caused by temporal variations in patient blood volume, e.g., associated with posture in the period before sample collection). This last effect is not adequately accounted for in many current diagnostic test situations: typical practice advocates that patients sit for about 10 minutes before collection of venipuncture blood—however this standard is not always adhered to, and the activity and posture of the patient before being seated for the blood draw can be quite variable. Hence the ability to directly measure the amount of water in a blood sample, or equivalently the amount of dissolved solids (mainly protein), represents an advance in the ability to measure small changes in blood analytes (particularly proteins) in a series of patient samples. While available desiccants may not remove all of the sample water due to the hygroscopic nature of proteins among the sample solids, the measured amounts of sample “dry solids” or “dried solids” in the sample vessel and water in the desiccant may be evaluated in relation to an empirical calibration scale generated using a series of samples having solids and water content determined by conventional highly accurate methods, in order to arrive at accurate solids and water measurements.

A further application of the measured dry sample weight (or equivalent weights determined as above) is to adjust the amounts of process reagents used in analysis of a sample to better preserve the desired stoichiometry with sample analytes. For example, in a SISCAPA protocol, it may be advantageous to adjust the amounts of disulfide reductants, alkylators, and trypsin to preserve a desired stoichiometric relationship with the amount of protein estimated to be in the sample. Such adjustments can be carried out under computer control using the sample dry weight to determine the volumes of reagents to be added to a sample well (or any other form of liquid vessel used om processing the sample) by a computer controlled pipetting system.

The relative amounts of sample solids and water measured by this approach allow normalization of analytical measurements to a consistent scale independent of variations in blood volume occurring in patients for reasons mentioned above.

In the context of blood samples, the dry solids or dried solids refers to dried blood as this term in understood in the art of micro-sampling of dried blood. Dried blood in this context contains, e.g., non-volatile solutes that remain in the sample after water has been removed. Such dried blood contains, e.g., protein, lipids, carbohydrates, salts, metabolites, medications and/or DNA.

### Analytical Standard

In another embodiment, the sample collection device is used to prepare a series of dried sample aliquots of one or more standard samples for use as calibrants, controls or standards for an analytical method. In one example, a pool of human blood is collected from healthy donors and precisely measured 50 μL aliquots are collected in sample collection devices of the invention and allowed to dry. The barcodes of these devices are recorded in connection with the details of the pooled sample (including any available independent analytical data obtained on the pool), the date of collection, device lot information, etc. The devices are then stored according to best practices (e.g., at −20 C). Prior to use in a routine analytical process, a set of such dried sample aliquots is removed from storage and processed through a relevant analytical process, together with any calibrating samples necessary to establish a reference scale for the amount of desired analytes. The analytical results of this process are used to establish reference values for the amount of analytes in the aliquoted standard samples, the precision of measurements across replicate aliquots, and any other characteristics of importance to support ongoing use of the aliquots as standard materials. In a preferred approach to analytical standardization, three such devices are removed from storage and placed, together with 93 patient samples, in each 96-sample batch processed in an automated analytical method. Averaged analytical values from the standard samples are used to provide single point calibration of analytical results (in relation to the standards' established analytical values) and to estimate the measurement precision for each analyte. Standard samples prepared in the collection device of the invention can be generated within an analytical laboratory (e.g., for its internal use in establishing long-term analytical stability) or provided by a commercial supplier of calibrators and controls (for sale to multiple laboratories).

In an embodiment, an important advantage of the sample collection device lies in the use of a single sample vessel, identified by a unique computer-readable code (e.g., a 1D or 2D barcode), for a series of steps from initial sample collection through transport, storage, placement in a format (e.g., 96-well format) suitable for automated liquid handling, and, in some embodiments, the initial processing steps in the analytical workflow (e.g., dissolution through digestion of the sample as described above). There is therefore a solid chain of identification from the sample donor through analysis, without recourse to identifier transcription or filter paper punching commonly required in the processing of conventional dried blood spots. In addition, the device facilitates re-arranging or re-arraying sets of samples from a single source (e.g., a patient or donor) to generate longitudinal series, or a collection of samples aimed at study for a specific purpose (e.g., biomarker validation in a disease indication).

The sample identifying code also facilitates a calendar-driven approach to collection of longitudinal samples from an individual.

The identification of the source and circumstances of the sample, and the association of sample information with the sample vessel, are aspects of a sample collection process. It is therefore envisioned that common mobile data collection and mobile communication devices, e.g., mobile computing devices, such as cellphones (“smartphones”) can be used with the device of the invention to ensure sample annotation. In one such embodiment, a subject prepares to collect a sample of finger prick blood by using a cellphone camera to photograph or scan a barcode or other computer-readable code from the sample vessel. The subject can identify themselves as the sample donor by a variety of means including photographing themselves (using the proximity in time between the self photo and the sample vessel code collection as evidence of association); by recording identification based on a biometric sensor (e.g., a iPhone fingerprint sensor, or a retinal scan); or by voiceprint identification based on spoken sounds recorded by the cellphone. In addition the subject can record audio, photographic and/or video clips, either with or without prompting by human or computer-generated agents, providing information about subject identity, the state of the subject's health and wellness, any alterations in normal routines, or any other noteworthy information useful to the subject, the analytical laboratory, healthcare providers, insurers, employers, computer game environments or others.

### EXAMPLE (SHOWN IN FIG. 10)

Tubular paper sample vessels were made of filter paper by spiral winding a narrow strip of filter paper around a glass capillary (˜1.3 8mm dia), and counter-winding with red thread. The filter paper and thread helices were tacked in place with hot glue from a gluegun, leaving a large majority of the paper surface uncovered. Two small rubber O-rings were placed on each tube as “bumpers” in order to keep the paper tubes from touching the molecular sieve beads on the walls of the vials. Sample vessels were approximately 50 mm long.

Desiccant vessels were prepared using large screw-cap barcoded vials with paper strips (3×5 cm) curled around the inside. A one-layer coating of small molecular sieve beads was adhered to this paper (as desiccant) with a thin coat of “5 min epoxy”. Thus the vial had an internal coating of molecular sieve beads around its circumference except for an open slot through which the sample vessel was visible from outside.

After the epoxy holding the molecular sieve beads had set, the vials were placed in a kitchen microwave oven for total 3 min on high to eliminate any water in the beads, and maximize the beads' desiccant capacity.

Empty sample vessels and prepared desiccant vessel were each weighed 6 times using a small electronic balance (Smart Weigh GEM50 scale: (http://betterbasics.com/guide/SW-GEM50) and the weights averaged to achieve ˜1 mg precision.

A sample vessel was placed in each of 4 desiccant vessel/vials with just an open end sticking out. The assembled devices were laid horizontally on a table and loaded with blood (delivered to the protruding end of the sample vessel) from a fingertip blood drop and kept horizontal. Vial caps were screwed on the vials, sealing them.

After a period of 16.6 h sample vessels were removed from the desiccant vessel/vials and the two parts weighed separately and reassembled. After a further 48 h these weighings were repeated.

After 16.6 h, the blood samples appeared dried and the lumens of the sample vessel capillary tubes were empty.

As shown in Table 1, the 4 replicate sample vessels imbibed blood volumes ranging from ˜112 to ˜132 uL, as expected given the variability of the devices made by hand. However the precision of the measured weights (+/−˜1 mg for 6 replicate measurements using a very inexpensive digital balance) allows normalization of the actual blood volume to >1%.

In <17 h after blood collection, ˜80% of the blood mass was relocated to the desiccant, indicating successful drying of the blood samples. Drying was confirmed by inspection of the sample vessels which showed empty lumens and thoroughly dried solid blood on the paper.

A further 48 h of drying showed no appreciable changes in the amount of water transferred.

These devices thus successfully collected ˜10 times the blood volume represented by a conventional dried blood spot punch (˜130 uL vs ˜14 uL), dried the blood independent of the ambient humidity, and provided an accurate measure of the blood volume actually collected. The dried blood was delivered in a format (narrow tube 50 mm long) compatible with subsequent processing in a deepwell 96 well plate.

### REFERENCES

Each of the following references is incorporated herein in its entirety.
1. Guthrie R, Susi A. A Simple Phenylalanine Method For Detecting Phenylketonuria In Large Populations Of Newborn Infants. Pediatrics. 1963;32(3):338-43.
2. Lehmann S, Delaby C, Vialaret J, Ducos J, Hirtz C. Current and future use of “dried blood spot” analyses in clinical chemistry. Clinical Chemistry and Laboratory Medicine. 2013 October; 51(10):1897-909.
3. Chambers A G, Percy A J, Yang J, Camenzind A G, Borchers C H. Multiplexed quantitation of endogenous proteins in dried blood spots by multiple reaction monitoring-mass spectrometry. 2013 March; 12(3):781-91.
4. Tanna S, Lawson G. Self-sampling and quantitative analysis of DBS: can it shift the balance in over-burdened healthcare systems? Bioanalysis. 2015 September; 7(16):1963-6.
5. Anderson N L, Anderson N G, Haines L R, Hardie D B, Pearson T W. Mass spectrometric quantitation of peptides and proteins using Stable Isotope Standards and Capture by Anti-Peptide Antibodies (SISCAPA). J Proteome Res. 2004 February; 3(2):235-44.
6. Anderson N L, Jackson A, Smith D, Hardie D, Borchers C, Pearson TW. SISCAPA peptide enrichment on magnetic beads using an in-line bead trap device. 2009 May; 8(5):995-1005.
7. Razavi M, Leigh Anderson N, Pope M E, Yip R, Pearson T W. High precision quantification of human plasma proteins using the automated SISCAPA Immuno-MS workflow. New Biotechnology. 2016 Sep. 25; 33(5 Pt A):494-502.
8. Rosting C, Gjelstad A, Halvorsen T G. Water-Soluble Dried Blood Spot in Protein Analysis: A Proof-of-Concept Study. Anal Chem. 2015 Aug. 4; 87(15):7918-24.
9. Statland B E, Bokelund H, Winkel P. Factors contributing to intra-individual variation of serum constituents: 4. Effects of posture and tourniquet application on variation of serum constituents in healthy subjects. Clin Chem. 1974; 20:1513-9.

what is claimed is:

1. A sample collection device, comprising a sample vessel comprising a sample absorber and optionally a desiccant vessel, the two vessels being reversibly joinable to each other or to the device, wherein the sample vessel comprises a sample absorber and the desiccant vessel comprises a quantity of desiccant sufficient to bind an amount of water at least equal to the amount of water contained in an imbibed sample, and wherein one or more, or any combination of: the device, sample vessel, sample absorber, or desiccant vessel comprises (a) at least one computer-readable code and (b) a predetermined weight to a precision of plus or minus 0.5 milligrams.

2. The device of claim 1, wherein the sample absorber comprises an internal capillary channel through which sample can flow, a rigid sample carrier by which the sample absorber can be manipulated without contacting the absorber, and optionally a desiccant, and a water-impermeable housing with one or more closable openings, wherein the desiccant vessel comprises a quantity of desiccant sufficient to bind an amount of water at least equal to the amount of water contained in an imbibed sample, and wherein the sample carrier optionally comprises at least one unique computer-readable code.

3. The device of claim 1, wherein the sample absorber comprises a sandwich of a rigid sample carrier between two sheets of the sample absorber, wherein the sample carrier comprises at least one unique computer-readable code and wherein the sample carrier has an internal slot which, in said sandwich, creates a capillary channel facilitating flow of sample into the device.

4. The device of claim 1, having a predetermined weight to a precision of plus or minus 1.0 milligrams.

5. The device of claim 1, wherein the sample absorber is configured to be introduced into 96 well format array for operation in an automated sample processing.

6. A plurality of two or more devices of claim 1, wherein the weight of each device is within 1.0 milligram of a predetermined weight.

7. The plurality of devices of claim 6, wherein the weight of each device is within 0.5 milligrams of a predetermined weight.

8. The plurality of devices of claim 6, wherein the plurality of devices is 100 or more devices.

9. A method for determining an amount of an analyte in a sample, comprising dissolving sample dried in or on the sample absorber in the sample collection device of claim 1 and analyzing the amount of one or more desired analytes in the dissolved sample.

10. The method of claim 9, further comprising placing the sample absorber or the sample vessel in a 96 well format array.

11. The method of claim 9, wherein the analysis includes determination of the amounts of said one or more analytes by mass spectrometry.

12. The method of claim 9, wherein the analysis includes protein denaturation, proteolytic digestion, and enrichment of preselected peptide analytes.

13. The method of claim 9, wherein a stable isotope labeled analyte is used in the analysis as an internal standard for mass spectrometric quantitation.

14. The method of claim 9, wherein a stable isotope labeled analyte is placed on the sample absorber and dried before contacting of sample with the sample absorber.

15. The method of claim 9, wherein tare weights of any one of, or any combination of: the device, the sample vessel, the sample absorber, the desiccant vessel are recorded prior to contacting of sample thereto.

16. The method of claim 15, wherein the tare weights recorded prior to contacting of are subtracted from respective weights after loading and drying of a sample to yield a sample's dry solids and/or water weight.

17. The method of claim 16, wherein the amount or concentration of an analyte determined in a sample is normalized using the sample's measured dry weight or water weight.

18. The method of claim 16, wherein the amount or concentration of an analyte determined in a sample is normalized using the sample's measured dry weight or water weight after correction for residual water remaining in the dried sample.

19. The method of claim 16, wherein the amount or concentration of an analyte determined in a blood sample is normalized using the sample's measured dry weight or water weight, and an estimate of the blood sample's hematocrit.

20. The method of claim 16, wherein the amount of sample, or of a component of a sample, estimated using a sample's total, dry, or water weights, is evaluated to determine whether or not the amount of sample is adequate to accurately allow measurement of an analyte.
